(19) United States
(12) Patent Application Publication
(10) Pub. No.: US 2015/0252965 A1
(43) Pub. Date: Sep. 10, 2015

(54) SOLID-STATE LINEAR LIGHTING ARRANGEMENTS INCLUDING LIGHT EMITTING PHOSPHOR

(71) Applicant: Intematix Corporation, Fremont, CA (US)

(72) Inventor: Charles Edwards, Pleasanton, CA (US)

(73) Assignee: INTEMATIX CORPORATION, Fremont, CA (US)

(21) Appl. No.: 14/641,237

(22) Filed: Mar. 6, 2015

Related U.S. Application Data
(60) Provisional application No. 61/949,997, filed on Mar. 7, 2014.
(60) Provisional application No. 61/994,092, filed on May 15, 2014.
(60) Provisional application No. 61/994,096, filed on May 15, 2014.
(60) Provisional application No. 61/994,099, filed on May 15, 2014.
(60) Provisional application No. 62/017,233, filed on Jun. 25, 2014.

(51) Int. Cl. F21K 99/00; B29D 11/00; F21V 29/70; B29C 47/00; F21V 3/04; F21V 7/22

(52) U.S. Cl. CPC F21K 9/56; F21V 3/049; F21V 7/22; F21V 29/70; B29C 47/0004; B29D 11/0074; F21Y 2103/003

(57) ABSTRACT

A lamp optical component comprises a hollow extruded component, where the hollow extruded component includes a photoluminescence portion and a light shaping portion, and where the photoluminescence portion extends into an interior volume of the hollow extruded component.

### CROSS-REFERENCE TO RELATED APPLICATIONS

This application claims the benefit of priority to U.S. Provisional Application No. 61/949,997, filed on Mar. 7, 2014, U.S. Provisional Application No. 61/994,092, filed on May 15, 2014, U.S. Provisional Application No. 61/994,096, filed on May 15, 2014, U.S. Provisional Application No. 61/994,099, filed on May 15, 2014, and U.S. Provisional Application No. 62/017,233, filed on Jun. 25, 2014, which are all hereby incorporated by reference in their entireties.

### FIELD

This disclosure relates to solid-state linear lighting arrangements including light emitting phosphor and photoluminescence wavelength conversion components. More particularly, though not exclusively, embodiments of the invention are directed to linear lighting arrangements such as troffers, pendant lights, wraparound lights, under cabinet lights and task lights.

### BACKGROUND

A common type of lighting apparatus that has achieved great commercial success is the linear lighting arrangement, in which the lighting apparatus typically has an elongated profile lamp with light emission along the length of the lamp. These linear lamps are commonly used in office, commercial, industrial and domestic applications and incorporate standard size linear lamps (such as standard tubular T5, T8, and T12 lamps).

A linear lighting apparatus that is commonly used in office and commercial applications is a ceiling-recess or troffer that is mounted within a modular suspended (dropped) ceiling. Other linear lighting apparatus include suspended linear arrangements that can be direct only (downward light emitting) or direct/indirect (lighting both the workspace in a downward direction and the ceiling in an upward direction for indirect lighting. Surface mount linear fixtures, often called wraparound lights or wrap lights, are used in both office, industrial and domestic spaces. These are typically mounted directly to the surface of the ceiling or wall. Task lighting and under-cabinet fixtures also common use linear tubular lamps as the light source.

FIG. 1 shows an example of a traditional troffer 2 that is often used to house fluorescent tube lamps in a modular suspended (dropped) ceiling. The interior of the troffer body 4 includes lamp holders (connectors) on both lateral ends of the arrangement to receive linear fluorescent tubes 6. To achieve desired lighting performance, most troffers are configured to receive several fluorescent tubes, since a single conventional tube by itself cannot usually provide enough light for typical applications. The troffer can include a panel or door 8 to allow for insertion and replacement of the fluorescent tubes 6. In addition, the panel/door 8 also provides a location to include a diffuser within the lighting arrangement.

While traditional fluorescent tube troffers, suspended linear, wraparound lights and under-cabinet lighting arrangements are very common and exist in almost every commercial office building, there are many disadvantages associated with such lighting configurations. The conventional troffer configurations tend to be relatively complex, given the number of disparate components (e.g., troffer housing, lamp connectors, lamp driver, separate diffusers, doors/panels, tubes) that need to be separately manufactured and then integrated together in the lighting arrangement. In addition, since each lamp (tube) requires electrical connection to each end, cabling has to be provided over a significant portion of the volume of the arrangement requiring greater and more extensive safety-related and certification-related reinforcements to the lighting fixture/troffer, increasing the size and weight of the arrangement. Moreover, fluorescent tubes in the conventional troffers suffer from spotty reliability and relatively inefficient lighting uniformity and performance. These problems therefore negatively affect the complexity, performance, weight, and/or cost to anyone that seeks to manufacture or install a linear light.

In addition, many disadvantages are also associated with the use of conventional fluorescent-based tube technology, which are gas discharge lamps that use electricity to excite mercury vapors. For example, the mercury within the fluorescent lamp is poisonous, and breakage of the fluorescent lamp, particularly in ducts or air passages, may require expensive cleanup efforts to remove the mercury (as recommended by the Environmental Protection Agency in the USA). Moreover, fluorescent lamps can be quite costly to manufacture, due in part to the requirement of using a ballast to regulate the current in such lamps. In addition, fluorescent lamps have fairly high defects rates and relatively short operating lives.

As is evident, there is a need for an improved approach to implement linear lighting arrangements that overcome the drawbacks of the conventional linear lamps.

### SUMMARY OF THE INVENTION

Embodiments of the invention concern an integrated lighting component and an improved linear lighting arrangement.

Embodiments of the present invention pertain to linear lamps that utilize solid-state light emitting devices, typically LEDs (Light Emitting Diodes) in combination with an integrated wavelength conversion component. The solid-state-based linear lamp of the present invention overcomes the problems associated with conventional fluorescent lamp fixtures. Unlike fluorescent lamps, solid-state-based linear lamps do not require any mercury. LED-based lamps are able to generate higher lumens per watt as compared to fluorescent lamps, while having lower defects rates and longer operating life expectancies.

Some embodiments pertain to a lamp component, comprising a hollow extruded component, where the hollow extruded component comprises a photoluminescence portion and a light shaping portion, and where the photoluminescence portion extends into an interior volume of the hollow extruded component and comprises at least one photoluminescence material.

According to some embodiments of the invention, the inventive lighting arrangement includes an integrated wavelength conversion component that resides within a troffer frame (housing), where an elongated substrate (e.g., circuit board) containing an array of LEDs is insertable within (or adjacent to) the integrated wavelength conversion component. The integrated wavelength conversion component includes one or more photoluminescence materials (e.g., phosphor materials) which absorb a portion of the excitation light emitted by the LEDs and re-emit light of a different color (wavelength). Instead of requiring a separate diffuser to be individually sourced and then added to the arrangement, the integrated wavelength conversion component includes a diffuser portion that is integrally formed into the integrated component.

One embodiment of a lighting fixture comprises a light reflective enclosure and an elongate solid-state light source located within the light reflective enclosure, wherein the elongate solid-state light source comprises an elongate array of solid-state light emitters and an elongate hollow optical component having an elongate wall defining an interior volume. A first elongate portion of the wall has a length that projects into the interior volume and has at least one photoluminescence material, a second elongate portion of the wall length emits at least some light in a direction away from the light reflective enclosure with the second portion of the wall length substantially without a photoluminescence material, and a third elongate portion of the wall length emits at least some light in a direction towards the light reflective enclosure, where the third portion of the wall length is substantially without a photoluminescence material.

In some embodiments, an optical component comprises a hollow elongate optical component comprising an elongate wall defining an interior volume, with the wall having a wall length. A first elongate portion of the wall length projects into the interior volume in a first direction and has at least one photoluminescence material. A second elongate portion of the wall length emits at least some light in the first direction, with the second portion of the wall length substantially without a photoluminescence material. A third elongate portion of the wall length emits at least some light in a direction opposite to the first direction, with the second portion of the wall length substantially without a photoluminescence material.

Another embodiment pertains to an optical component comprising a hollow elongate optical component comprising a wall defining an interior volume, with the wall having a wall length. A first elongate portion of the wall length projects into the interior volume in a first direction and has at least one photoluminescence material. A second elongate portion of the wall length emits at least some light in the first direction, with the second portion of the wall length substantially without a photoluminescence. The optical component wall in this embodiment has a wall profile that is non-circular in shape.

Some embodiments pertain to a lamp component comprising a hollow co-extruded component, the hollow co-extruded component having a photoluminescence portion, a diffuser portion, and a top portion, where the photoluminescence portion, the diffuser portion, and the top portion are all integrally formed in the co-extruded component. The photoluminescence portion extends into an interior volume of the hollow co-extruded component and comprises at least one photoluminescence material. The diffuser portion comprises diffusing material and the top portion comprises an optically transparent material.

The combination of the photoluminescence portion and the top portion forms a channel to receive a substrate having electrical components. Alternatively, the lamp component may include one or more protrusions on the top portion to receive a substrate having electrical components.

The combination of the photoluminescence portion, the diffuser portion, and the top portion integrally form a single-walled structure having the interior volume that is closeable by, for example, the application of end caps over the open ends of the lamp component. The lamp component may include a diffuser portion that forms a rounded shape or a V-shape. The photoluminescence portion can comprise a part elliptical, rounded (arcuate), or generally V-shape profile.

Some embodiment pertain to a linear lighting arrangement comprising a hollow co-extruded component, the hollow co-extruded component having a photoluminescence portion, a diffuser portion, and a top portion, where the photoluminescence portion, the diffuser portion, and the top portion are all integrally formed in the hollow co-extruded component. The arrangement further includes a troffer body for receiving the co-extruded component. The troffer body may not include electrical conduits, and the troffer body comprises a plastic and/or light-reflective material. The diffuser portion comprises diffusing material for generating direct lambertian light emissions and the top portion comprises an optically transparent material for directing emitted light upwards to be reflected from the troffer body for indirect light emissions.

A method of fabricating an optical component is provided. In some embodiments, an elongated hollow body is co-extruded to include a photoluminescence portion, a diffuser portion, and a top portion. The photoluminescence portion, the diffuser portion, and the top portion are all integrally formed in the body, the photoluminescence portion projecting into an interior volume of the co-extruded component and comprising at least one photoluminescence material, the diffuser portion comprising diffusing material, and the top portion comprising an optically transparent material. Multiple separate extruders are employed to extrude materials of the photoluminescence portion, the diffuser portion, and the top portion. The materials operated upon by the extruders include at least one of Polycarbonate, Poly(methyl methacrylate), Polyethylene Terephthalate, and thermoform plastics. In some embodiments, vacuum extrusion is performed to extrude the optical component.

Some embodiments pertain to a lighting fixture comprising a linear solid-state light source or array of sources on a substrate located within an interior of the fixture, a linear heat sink adjacent to the substrate having the linear light source, a tubular optical element that is greater than two inches in width that integrally includes a diffuser surface substantially facing in the direction of light emission, wherein the tubular optical element is linear in shape and is attached to the linear light source, the linear light source combined with the tubular optical element provides light emissions in both the upward and downward directions, and a single walled molded troffer body formed of a non-ferrous material and being light reflective, wherein the troffer body is reflective and the tubular optical element is mounted within the troffer body. In some embodiments, at least 25% of total light output from the light fixture is indirectly reflected from the troffer body and at least 25% of the total light is directly emitted through the diffuser surface from the linear light source. The troffer body may correspond to at least 95% reflectivity. The troffer body can be comprised of a plastics material. The linear light source is located at approximately 20% of the center of the light fixture in both the horizontal and vertical directions. In addition, the linear optical element in combination with the heat sink can act as an approved electrical enclosure. The light fixture can be configured such that one end of the linear light source shares an electrical enclosure with a power supply such that the power supply and the optical element houses all electronics in the fixture so that the troffer body and remaining troffer structure forms a passive reflector with no electrical requirements or enclosure.

According to some embodiment, a linear pendant light is described. The pendant-based arrangement comprises a co-extruded component, the co-extruded component comprising a photoluminescence portion, a diffuser portion, and a top portion, wherein the photoluminescence portion, the diffuser portion, and the top portion are all integrally formed in the co-extruded component. The arrangement further includes a support structure for hanging the co-extruded component as a pendant light fixture.

Some embodiments pertain to a linear lighting arrangement comprising white LEDs and a hollow co-extruded component. In this embodiment, the hollow co-extruded component comprises a diffuser portion and a top portion. The hollow co-extruded component may also include a photoluminescence portion, although not necessary in all cases if the white LED already includes an encapsulant having photoluminescence materials.

In some embodiments, the integrated wavelength conversion component includes a housing portion that encompasses a wavelength conversion portion (having one or more phosphors) and part of the upper body portion (formed of clear materials). The housing portion includes slots to receive the substrate and the heat sink. Both the circuit board and the heat sink are mounted within the component, by inserting the edges of the circuit board and the heat sink along and through the slots. The heights of the slots are configured to accommodate the combined thickness of the substrate and the base of the heat sink. The heat sink therefore extends along the entire length of the integrated wavelength component adjacent to the circuit board. End caps can be placed at the ends of the integrated wavelength component, screws used to affix the end caps to the troffer body, thereby also rigidly holding the integrated wavelength component in a designated position within the troffer body. The power supply can be attached to the exterior surface of the troffer body in electrical communication with the circuit board. A power supply enclosure can be affixed to the troffer body in a position that surrounds and protects the power supply.

The troffer body can be formed of any suitable materials, e.g., plastic or polycarbonate. The interior of the troffer body is light reflective (e.g., due to a light reflective coating or because the body is constructed of a light reflective material) so that light emitted from the integrated wavelength conversion component in an upward (indirect) direction will be subsequently reflected at a downwards direction. The interior of the troffer body includes curved surfaces to reflect light in a downwards direction, with the specific configuration of the curved surfaces to promote a desired light emission pattern. The troffer body can be sized so that it fits within standardized ceiling tile configurations.

In some embodiments, the substrate comprises a strip of MCPCB (Metal Core Printed Circuit Board). The metal core base of the circuit board is mounted in thermal communication with the heat sink, e.g., with the aid of a thermally conducting compound such as for example a material containing a standard heat sink compound containing beryllium oxide or aluminum nitride. One or more solid-state light emitters (e.g., LEDs) is/are mounted on the circuit board. The LEDs can be configured as an array, e.g., in a linear array and/or oriented such that their principle emission axis is parallel with the projection axis of the lamp. The heat sink is made of a material with a high thermal conductivity (typically ≧150 Wm⁻¹K⁻¹, preferably ≧200 Wm⁻¹K⁻¹) such as for example aluminum (≈250 Wm⁻¹K⁻¹), an alloy of aluminum, a magnesium alloy, a metal loaded plastics material such as a polymer, for example an epoxy.

The upper portion of the integrated wavelength conversion component is located along the top of the integrated wavelength conversion component on either side of the housing. The upper portion can be implemented as an optically transparent substrate (window) or lens through which light emitted by the wavelength conversion portion can be emitted in an upwards direction. In a troffer arrangement, this upwards emission permits emitted light to be directed at (and to widely “fill”) the interior surface of the troffer body, and to then be reflected outwards in directions controlled by the configuration of the angled/curved interior of the troffer body. In some embodiment, the upper portion comprises a clear polycarbonate or plastics material.

The diffuser portion can be located along the lower portion of the integrated wavelength conversion component. The diffuser portion provides a diffuser that is integrated within the rest of the integrated wavelength conversion component. This means that the lighting arrangement does not need to include any other separate diffuser in order to diffuse the light that is emitted from the wavelength conversion portion. The diffuser portion can be configured to include light diffusive (scattering) material. Example of light diffusive materials include particles of Zinc Oxide (ZnO), titanium dioxide (TiO₂), barium sulfate (BaSO₄), magnesium oxide (MgO), silicon dioxide (SiO₂) or aluminum oxide (Al₂O₃). The shape of the diffuser portion contributes greatly to the final emissions characteristics of the lighting arrangement. In some embodiments, the integrated wavelength conversion component includes a generally V-shaped lower profile for the diffuser portion. In an alternate embodiment, a rounded (arcuate) lower profile is provided.

The shape of the wavelength conversion portion can be configured to emit photoluminescence light with any desired emissions characteristics. In some embodiments, the wavelength conversion portion is shaped to more effectively promote the effective distribution of light by the diffuser portion. For example, the wavelength conversion portion can have a lower generally V-shape or part elliptical profile that generally and evenly directs photoluminescence light across the surface of the diffuser portion.

The combination of the clear top portion and the diffuser portion permits separate control of the indirect and direct light patterns emitted by the lighting arrangement. The light emitted upwards (indirect emission) through the clear top portion permits a wide angle, upward emission designed for optimal fill from the arrangement. The light emitted downwards (direct emission) through the diffuser portion provides a forward lambertian emission by direct light from the arrangement.

The wavelength conversion portion can be formed of and/or include any suitable photoluminescence material(s). In some embodiments, the photoluminescence materials comprise phosphors. However, the invention is applicable to any type of photoluminescence material, such as either phosphor materials or quantum dots.

The design of the present embodiments permits a more compact and efficient design that more efficiently isolates the electrical portions of the arrangement. Here, the electrical portions of the lamp is fully contained within the housing portion and is further electrically isolated in either end via the end caps to the power supply and the enclosure. There are no additional wiring structures or conduits required through any part of the troffer assembly. This inherent electrical isolation through a very compact space permits the embodiments of the invention to generally require only a relatively small portion of the lamp at or within the housing portion to require any special requirements for dimensions and/or materials (if necessary at all) to meet certification requirements, potentially allowing the rest of the lamp to be formed with less stringent requirements for dimensional thicknesses and/or specific materials. This can reduce the overall cost, weight, and complexity of the design or the lamp. Therefore, the isolation of the electrical components to the single compact portion through component (rather than through a troffer) allows for the troffer body to be configured with a much lighter and cheaper material composition (e.g., a plastic reflector material). This results in much lower costs, easier manufacturing, and lowered final weight for the lighting arrangement.

In some embodiments, the linear optical element combined with the heat sink acts as an approved electrical enclosure. One end of the linear solid state light source or array shares an electrical enclosure with the power supply such the power supply and linear optical element house all electronics in the fixture, allowing the reflective body and remaining troffer structure to be a passive reflector with no electrical requirements or enclosure. In some embodiments, the total weight of the plastic troffer is less than 6 lbs for a 2×2 troffer and less than 12 lbs for a 2×4 troffer of which greater than 70% is plastic.

It is noted that the integrated nature of the integrated wavelength conversion component also provides numerous advantages. Integrating the wavelength conversion component with an enclosure having other portions (such as the diffuser portion) that forms a unitary component avoids many problems associated with having them as separate components. With the present invention, the integrated component can be assembled without requiring components for these functional portions, and without requiring separate assembly actions to place them into a lighting arrangement. In addition, significant material cost savings can be achieved with the present invention. The overall cost of the integrated component is generally less expensive to manufacture as compared to the combined costs of having a separate wavelength conversion component and a separate diffuser component. In addition, separate packaging costs would also exist for the separate component. Moreover, an organization may incur additional administrative costs to identify and source the separate components. By providing an integrated component that integrates the different portions together, many of these additional costs can be avoided.

The present invention also provides better light emission characteristics for the lighting arrangement. This is particularly advantageous since the lighting arrangement allows for both upper (indirect) and lower (direct) light emissions from the integrated component. The design of the present embodiment is particularly unique, given the “floating” nature of the indirect/direct sealed optical element placed in the interior and/or center of the component (not against a reflector wall). In addition, the troffer design can be simplified, since a separate diffuser and panel/door are no longer needed and a socket is not needed for fluorescent tubes.

According to some embodiment, a troffer lighting fixture comprises a single linear solid-state light source or array of sources on a single linear PCB located within 20% of the center of the fixture in both the horizontal and vertical directions. The linear light source is attached to a tubular optical element greater than two inches in width that includes a diffuser surface substantially facing in the direction of light emission. The linear light source combined with the tubular linear optical element provides both direct and indirect emission of at least 25% in both the upward and downward directions.

In one embodiment, a single walled molded troffer body is provided that corresponds to greater than 95% reflectivity that is made of plastic or similarly formed non-ferrous material. In some embodiments, the troffer provides at least 25% of the total light coming from indirect reflection off of the reflective body and at least 25% of emission coming from direct emission from the forward facing diffuser attached to the linear light source.

The advanced design of the invention therefore provides for better light uniformity, high reliability, and improved performance, while at the same time allowing for lower costs, less complexity, lower weight requirements, and much improved assembly efficiencies.

Different combinations can be configured for the troffer body and integrated wavelength conversion component. An integrated wavelength conversion component having a rounded lower or a generally V-shaped profile can be used in combination with a troffer body. In some embodiments, the interior walls of the troffer body are curved throughout the troffer. This means that the ends of the integrated wavelength conversion component are sloped/curved to match the curved shape of the interior walls of the troffer. This configuration is different from an approach where the end walls of the troffer body are perpendicular rather than curved, which means that the ends of the integrated wavelength conversion component in these embodiments do not need to be sloped/curved.

In some embodiment, the integrated wavelength conversion component is used to form a pendent lamp. Here, the integrated wavelength conversion component is suspended from a ceiling using suspension structures, e.g., support rods or cables attached to a heat sink support structure. This application of the component is feasible due to the integrated nature of the component, since no additional components are needed to provide a diffuser or support structure for the LEDs/circuit board. Because a troffer does not need be included in this pendant lamp application, there is no need for light to be emitted from the top of the lamp. Therefore, the top portion of the component does not need to be formed of a clear material. Instead, the top portion can be formed as a reflector portion. In this embodiment, the reflector portion can comprise a light reflective material, e.g., a light reflective plastics material. Alternatively the reflector can comprise a metallic component or a component with a metallization surface.

In other pendant lamp embodiments the top portion can emit light to illuminate the ceiling. The spacing of pendant lamps and/or troffers can be selected to ensure a uniform illumination at specified height(s) within the environment.

An alternative embodiment uses white LEDs, where the photoluminescence material is provided in a material that directly encapsulates the LED chip. Since the photoluminescence material is provided as part of the structure of the LED chip on the substrate, this means that portion in the integrated component does not need to include photoluminescence material. Instead, the materials used to form portion can be made of a transparent material, e.g., a clear polycarbonate or other plastics material or a light diffusive material. In yet another embodiment, photoluminescence material can be included in both an encapsulant for the LEDs as well as in portion.

In embodiments where the integrated component has a constant cross section (profile), it can be readily manufactured using an extrusion method. Some or all of the integrated component can be formed using a light transmissive thermoplastics (thermo-softening) material such as polycarbonate, acrylic or a low temperature glass using a hot extrusion process. Alternatively some or all of the component can comprise a thermosetting or UV curable material such as a silicone or epoxy material and be formed using a cold extrusion method. A benefit of extrusion is that it is relatively inexpensive method of manufacture. Different types of extrusion processes may be used to manufacture the integrated wavelength conversion component. In some embodiments, a vacuum extrusion approach is performed to manufacture the integrated wavelength conversion component.

In some embodiments, a heat sink can be integrally formed into the integrated wavelength conversion component. In this approach, material for the heat sink is provided to the extrusion head by a separate extruder, and the heat sink material is used to extrude the portion of the component adjacent to the intended location of the circuit board having the LEDs. Any suitable material may be used as the heat sink material, so long as the material has sufficient thermal conductance properties adequate to handle the amounts of heat to be generated by the specific lighting application/configuration to which the invention is directed. For example, thermally conductive plastics or polymers having thermally conductive additives may be used as the source material for the extruder that forms the heat sink portion of the component. The integrally formed heat sink may be used to avoid the need to add an external heat sink during the manufacturing process for the lamp. Alternatively, the integrally formed heat sink may be used in conjunction with an external heat sink.

Some embodiments pertain to surface mountable linear lighting arrangements, such as for example wraparound lamps, where the wavelength conversion and top portions are integrally formed, but the bottom portion comprises a separate component. These different portions may be manufactured using any suitable manufacturing approach. For example, all of these portions can be extruded, albeit not co-extruded when manufactured separately. Alternatively, some of the portions are not extruded, but are instead manufactured using a different manufacturing approach (e.g., vacuum molded).

Having the components separately manufactured but capable of being assembled together into a single lighting arrangement provides numerous advantages. In some embodiments, this approach permits individually formed combinations of selectable properties for the top portions relative to the selectable properties of the bottom portions. For example, the integral top portion/wavelength conversion portions may be manufactured such that the top portion for a first variant of the top portion component is clear while a second variant of the top portion component is reflective. Meanwhile, the bottom portion is manufactured in a first variant to include diffuser materials, while a second variant does not include diffuser materials. This permits a first combination where the top portion is clear while the bottom portion comprises a diffuser, a second combination where the top portion is clear while the bottom portion is without diffuser, a third combination where the top portion is reflective while the bottom portion comprises a diffuser, and a fourth combination where the top portion is reflective while the bottom portion is without a diffuser.

Another advantage of having the component in two parts is that this enables the mounting and electrical connection of the power supply within the lighting arrangement. This also provides a way for installation and/or maintenance personnel to access the interior of the lighting arrangement, while still allowing the final arrangement to be assembled to have a closed-wall profile.

The bottom portion (e.g., diffusive portion) and top portion (e.g., light reflective portions) can include features enabling them to be secureably attached to each other by, for example, a snap fit. In some embodiments, the light reflective portions can be substantially rigid and the light diffusive portion can be resiliently deformable enabling insertion of the light diffusive portion by mechanical flexing.

Some embodiments of the invention are directed at a surface mountable linear lamp having an integrated wavelength conversion component. Another embodiment pertains to a task light having an integrated wavelength conversion component.

### BRIEF DESCRIPTION OF THE DRAWINGS

In order that the present invention is better understood LED-based light emitting devices and photoluminescence wavelength conversion components in accordance with the invention will now be described, by way of example only, with reference to the accompanying drawings in which like reference numerals are used to denote like parts, and in which:

FIG. 1 shows an example of a traditional ceiling-mountable troffer;

FIGS. 2A-C respectively show a perspective view, an exploded perspective view and a sectional end view through A-A of an improved troffer-based lighting arrangement according to some embodiments of the invention;

FIGS. 3A-B respectively show a perspective exploded view and an enlarged end view of an LED-based linear lamp according to an embodiment of the invention;

FIG. 4A-E shows various views of a troffer body utilized in the troffer-based lighting arrangement of FIGS. 2A-C;

FIG. 5A-C respectively show a perspective view; an end view, and an enlarged end view of the housing portion of an integrated wavelength conversion component;

FIG. 6 is a polar diagram showing the angular emission characteristic of the integrated wavelength conversion component of FIGS. 5A-C illustrating direct and indirect emission of the component;

FIG. 7A shows a perspective exploded view of an alternative troffer-based lighting arrangement according to an embodiment of the invention comprising a metal box enclosure;

FIG. 7B shows a perspective exploded view of a further troffer-based lighting arrangement according to an embodiment of the invention having a metal troffer body;

FIGS. 8A-C respectively show a perspective view; an end view, and an enlarged end view of the housing portion of an integrated wavelength conversion component in which the integrated wavelength conversion component has a diffuser portion that has a rounded profile for the lower portion;

FIGS. 9A-C respectively show a perspective view; an end view, and an enlarged end view of the housing portion of an integrated wavelength conversion component in which the integrated wavelength conversion component includes protrusions on the upper portion to form recesses for receiving a circuit board;

FIGS. 10A-B respectively illustrate a plan view and perspective end sectional view through B-B of a troffer-based lighting arrangement with an integrated wavelength conversion component having a rounded lower profile;

FIGS. 11A-B respectively illustrate a plan view and perspective end sectional view through C-C of a troffer-based lighting arrangement with an integrated wavelength conversion component having a generally V-shaped lower profile;

FIGS. 12A-C respectively illustrate a plan view, a perspective end sectional view through D-D and an exploded perspective view of a troffer-based lighting arrangement in which the interior walls of the troffer body are curved throughout the troffer body;

FIGS. 13A-B respectively show a perspective view and an exploded perspective view of a pendant lamp according to an embodiment of the invention;

FIG. 14 illustrates a process for co-extruding the integrated wavelength conversion component;

FIGS. 15A-D respectively illustrate first and second perspective views, an exploded perspective view and an end view (without end caps) of a surface mountable wraparound linear lamp according to an embodiment of the invention;

FIGS. 16A-B, 17A-B, 18A-B, 19A-B, 20A-B, and 21A-B each illustrate perspective and end views of alternate embodiments of integrated wavelength conversion components for surface mountable wraparound linear lamps;

FIGS. 22A-D respectively illustrate first and second perspective views, an exploded perspective view and an end view (without end caps) of an alternative surface mountable wraparound linear lamp;

FIGS. 23A-B respectively illustrate perspective and end views of the integrated wavelength conversion component of the surface mountable wraparound linear lamp of FIG. 22A-D;

FIGS. 24A-E respectively illustrate first and second perspective views, a partial exploded perspective view, fully exploded perspective view and an end view (without end caps) of a further surface mountable wraparound linear lamp;

FIGS. 25A-B respectively illustrate perspective and end views of the integrated wavelength conversion component of the surface mountable wraparound linear lamp of FIG. 24A-E;

FIGS. 26A-D respectively illustrate a perspective view, first and second exploded perspective views and an end view of a task light according to an embodiment of the invention;

FIGS. 27A-B respectively illustrate perspective and end views of an integrated wavelength conversion component for the task light of FIG. 26A-D;

FIGS. 28A-D respectively illustrate first and second perspective views, an exploded perspective view and an end view (without end caps) of a task light according to an embodiment of the invention;

FIGS. 29A-B respectively illustrate perspective and end views of an integrated wavelength conversion component for the task light of FIGS. 28A-D;

FIGS. 30A-C respectively illustrate a perspective view, an exploded perspective view and an end view of a mini task light according to some embodiments of the invention; and

FIGS. 31A-B respectively illustrate perspective and end views of an integrated wavelength conversion component for the mini task light of FIGS. 30A-C.

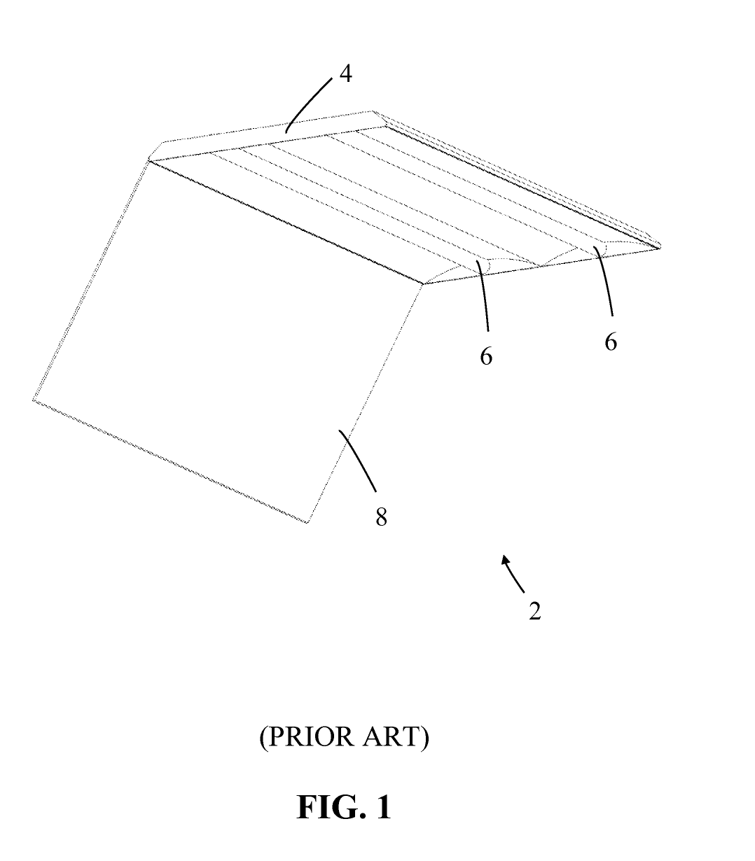

### DETAILED DESCRIPTION OF THE INVENTION

Embodiments of the present invention pertain to linear lamps that utilize solid-state light emitting devices, typically LEDs (Light Emitting Diodes) in combination with an integrated wavelength conversion component.

### Troffer-Based Lighting Arrangements

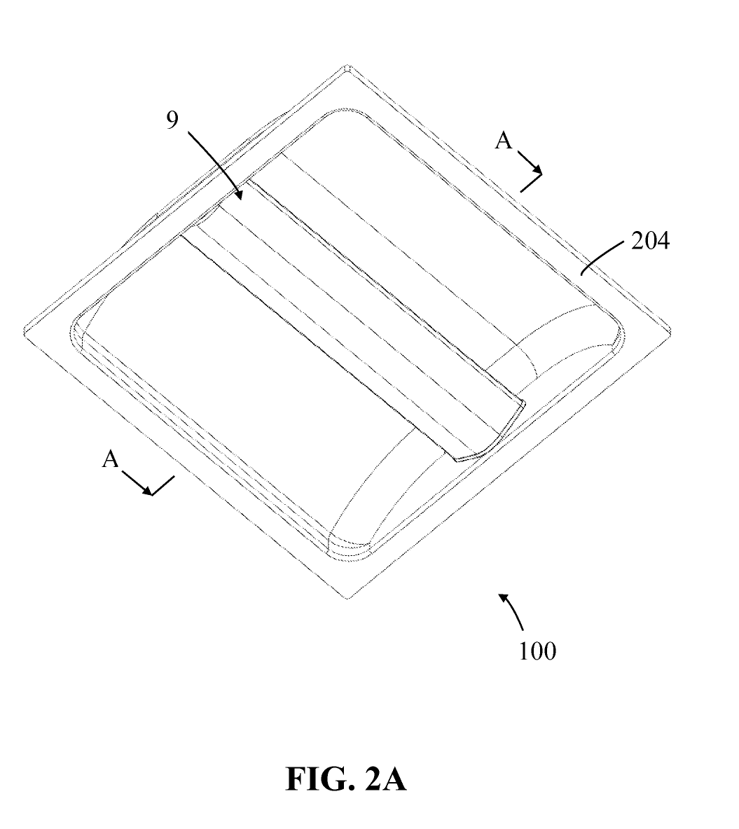

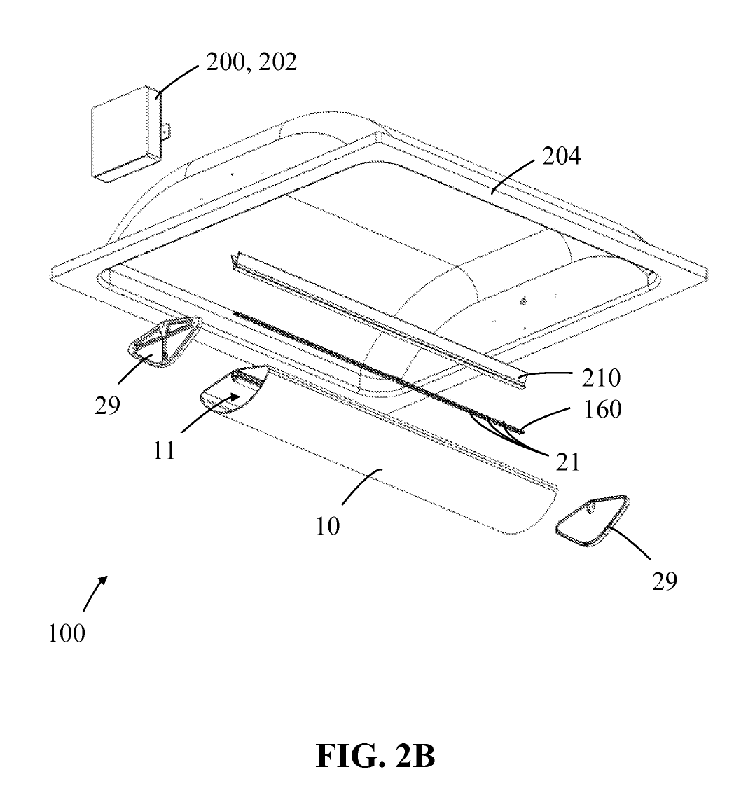

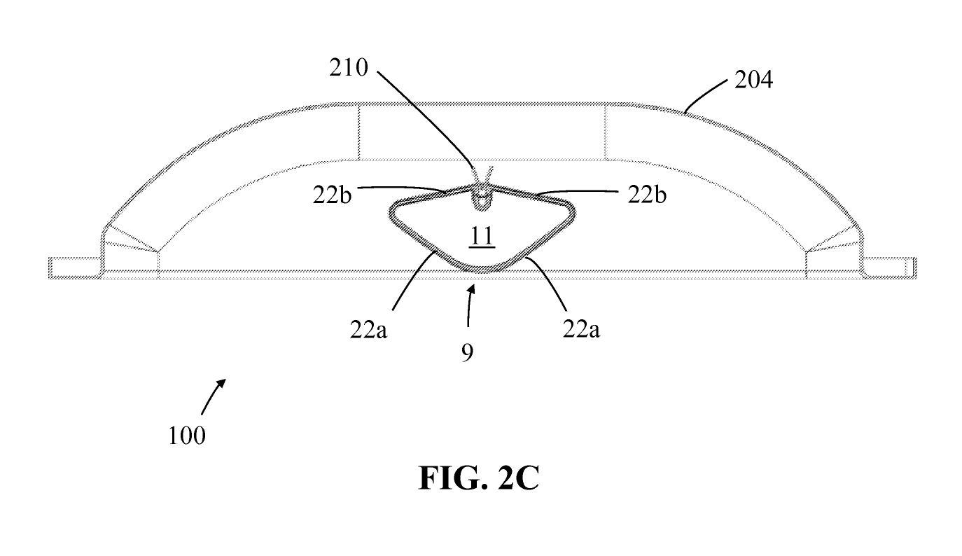

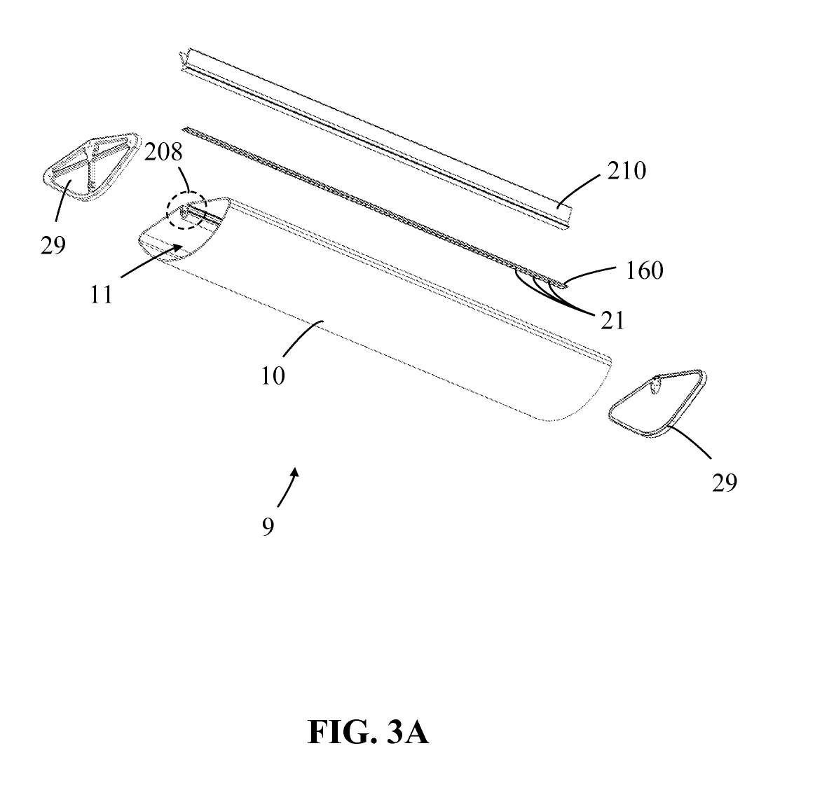

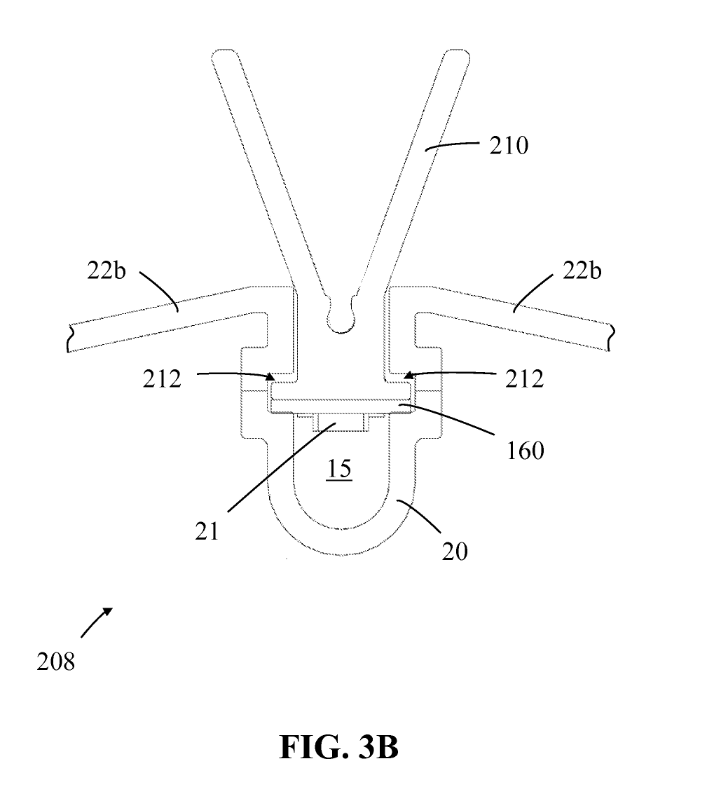

FIGS. 2A-C illustrate an improved troffer-based lighting arrangement 100 according to some embodiments of the invention that can be mounted in a suspended ceiling as are commonly found in offices. FIGS. 2A-C respectively show a perspective view, an exploded perspective view and a sectional end view through A-A of the troffer-based lighting arrangement 100. FIGS. 3A-B show a perspective exploded view and an enlarged end view of an LED-based linear lamp 9 according to an embodiment of the invention for the troffer-based lighting arrangement 100. The lighting arrangement 100 comprises a LED-based linear lamp 9 that resides within a light reflective troffer body (frame or enclosure) 204. The linear lighting arrangement 9 comprises a hollow integrated wavelength conversion component 10. An elongated substrate 160 (e.g., circuit board) containing a linear array of LEDs 21 is insertable within (or adjacent to) the integrated wavelength conversion component 10.

The hollow integrated wavelength conversion component 10 includes one or more photoluminescence materials (e.g., phosphor materials) which absorb a portion of the excitation light emitted by the LEDs 21 and re-emit light of a different color (wavelength). In some embodiments, the LED chips generate blue light and the phosphor(s) absorbs a percentage of the blue light and re-emits yellow light or a combination of green and red light, green and yellow light, green and orange or yellow and red light. The portion of the blue light generated by the LED chips that is not absorbed by the phosphor material combined with the light emitted by the phosphor provides light which appears to the eye as being nearly white in color. Alternatively, the LED chips may generate ultraviolet (UV) light, in which phosphor(s) absorb the UV light to re-emit a combination of different colors of photoluminescence light that appear white to the human eye. UV light may be useful, for example, in combination with certain compatible phosphor materials such as blue and green light. As is evident, the invention may be practiced using any combination of LEDs 21 that produce different colors of light. For example, another embodiment may include an array of LEDs 21 that comprise both blue LEDs and red LEDs.

Instead of requiring a separate diffuser to be individually sourced and then added to the troffer-based lighting arrangement 100, the integrated wavelength conversion component 10 in some embodiments of the present invention includes a lower diffuser portion 22a that is integrally formed into the component 10.

The lighting arrangement 100 further includes a power supply 200 to supply electrical power to the LEDs 21 on the circuit board 160. A power supply enclosure 202 can surround all and/or part of the power supply 200.

FIG. 3A shows an exploded view of the LED-based linear lamp 9 comprising an assembly of the integrated wavelength conversion component 10, wavelength conversion component end caps 29, the substrate 160, and a heat sink 210. As discussed further below with regard to FIG. 3B, the integrated wavelength conversion component 10 includes a housing portion 208 that encompasses a wavelength conversion portion 20 (having one or more phosphors) and part of the upper body portion 22b (formed of light transmissive, clear, materials). The housing portion 208 includes channels (slots) 212 to receive the substrate 160 and the heat sink 210. As shown in the magnified vie of FIG. 3B, both the circuit board 160 and the heat sink 210 are mounted within the component 10, by inserting the edges of the circuit board 160 and the heat sink 210 along and through the channels 212. It is noted that the combined thickness of the substrate 160 and the base (foot portion) of the heat sink 210 is configured to fit within the height of the slots 212. The heat sink 210 extends along the entire length of the integrated wavelength component 10 adjacent to the circuit board 160.

The end caps 29 are placed at the open ends of the integrated wavelength component 10. Screws or other fixtures can be used to affix the end caps 29 to the troffer body 204, thereby also rigidly holding the integrated wavelength component 10 in a designated position within the troffer body 204. The power supply 200 is attached to the exterior surface of the troffer body 204 in electrical communication with the circuit board 160. The power supply enclosure 202 is affixed to the troffer body 204 in a position that surrounds and protects the power supply 200.

FIG. 2C is a sectional end view along A-A illustrating the relative positioning of the the LED-based linear lamp 9 within the troffer body 204. The troffer body 204 can be formed of any suitable materials, e.g., plastic or polycarbonate. The interior of the troffer body 204 is light reflective (e.g., due to a light reflective coating or because the body 204 is constructed of a light reflective material) so that light emitted from the integrated wavelength conversion component 10 in an upwards direction will be subsequently reflected at a downwards direction. The interior of the troffer body 204 includes curved surfaces to reflect light in a downwards direction (i.e. in a direction toward the troffer body opening), with the specific configuration of the curved surfaces to promote a desired light emission pattern.

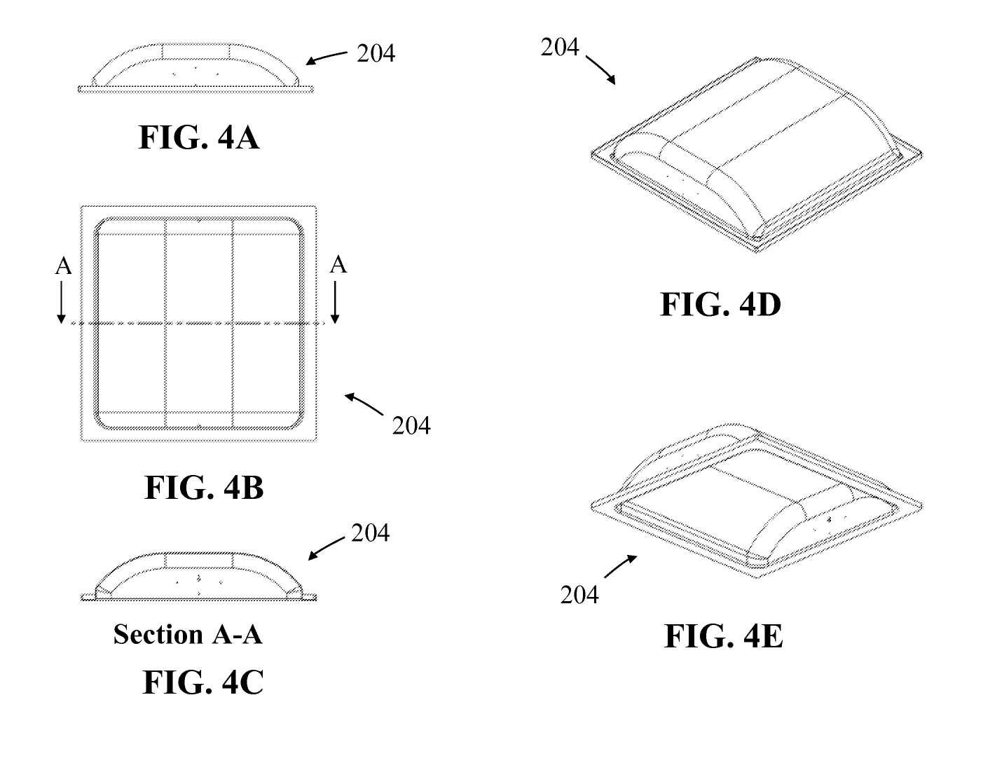

The troffer body 204 can be sized so that it fits within standardized ceiling tile configurations. FIG. 4A-E respectively shows a first end view, a plan view, a sectional end view along A-A, an upper perspective view and a lower perspective view of the troffer body 204.

In some embodiments, the substrate 160 comprises a strip of MCPCB (Metal Core Printed Circuit Board). As is known a MCPCB comprises a layered structure composed of a metal core base, typically aluminum, a thermally conducting/electrically insulating dielectric layer and a copper circuit layer for electrically connecting electrical components in a desired circuit configuration. The metal core base of the circuit board 160 is mounted in thermal communication with the heat sink 210, e.g., with the aid of a thermally conducting compound such as for example a material containing a standard heat sink compound containing beryllium oxide or aluminum nitride.

One or more solid-state light emitters (e.g., LEDs 21) are mounted on the circuit board 160. Each solid-state light emitter 21 can comprise a gallium nitride-based blue light emitting LED operable to generate blue light with a dominant wavelength of 455 nm-465 nm. The LEDs 21 can be configured as an array, e.g., in a linear array and/or oriented such that their principle emission axis is orthogonal to the longitudinal axis of the circuit board 160.

The heat sink 210 is made of a material with a high thermal conductivity (typically ≧150 Wm⁻¹K⁻¹, preferably ≧200 Wm⁻¹K⁻¹) such as for example aluminum (≈250 Wm⁻¹K⁻¹), an alloy of aluminum, a magnesium alloy, a metal loaded plastics material such as a polymer, for example an epoxy. The heat sink 210 can be manufactured using any suitable manufacturing process, e.g., extruded, die cast (e.g., when it comprises a metal alloy), extruded, and/or molded, by for example injection molding (e.g., when it comprises a metal loaded polymer).

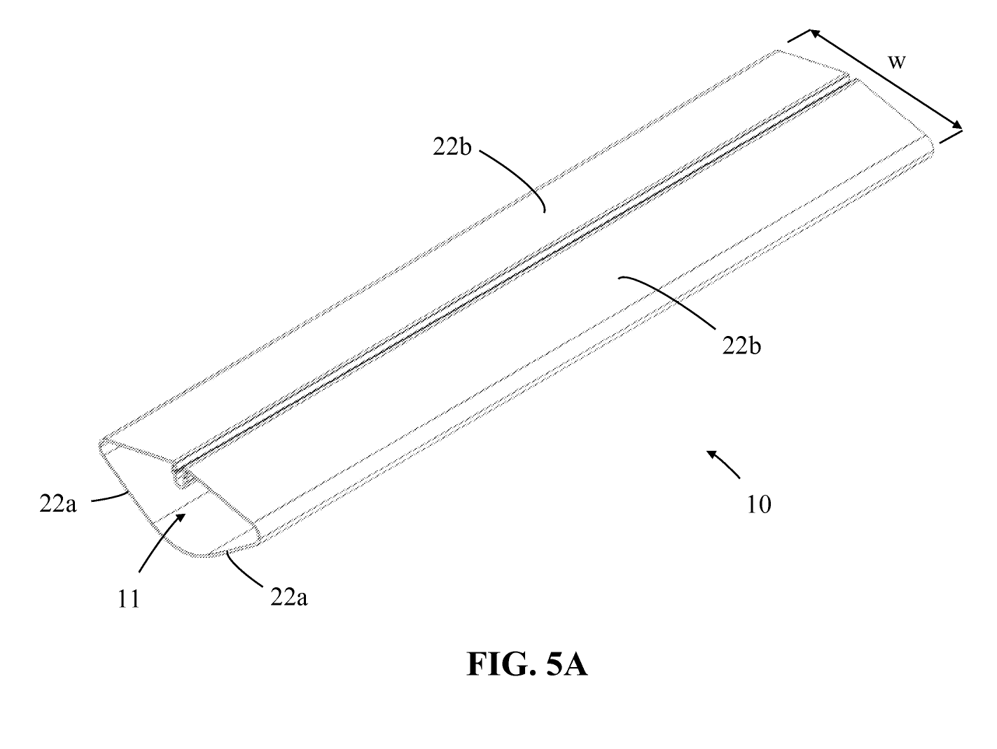

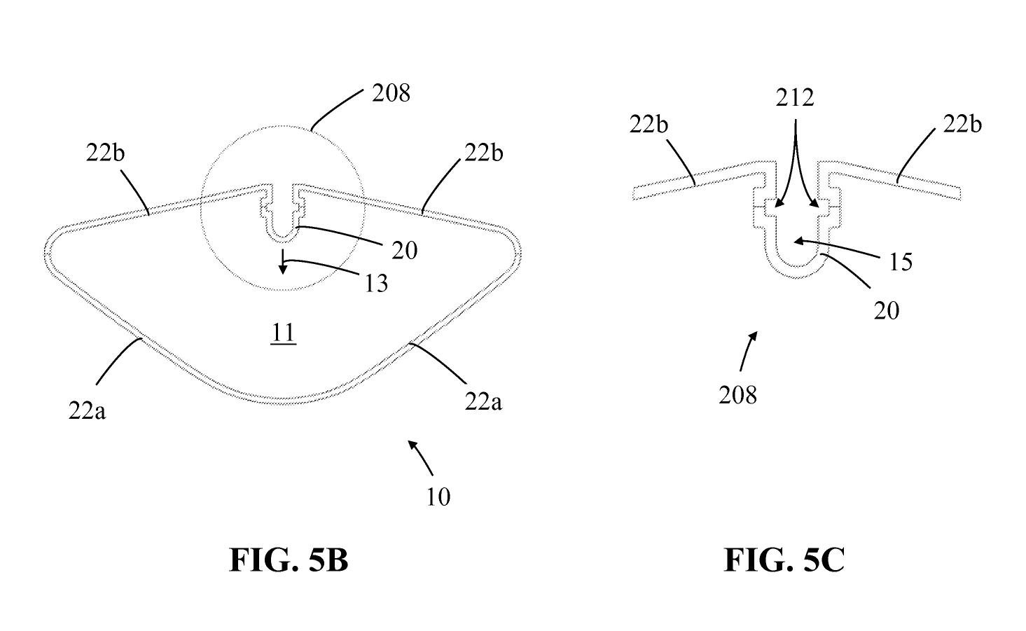

FIG. 5A provides a more detailed perspective view of the integrated wavelength conversion component 10. FIG. 5B shows an end view of the integrated wavelength conversion component 10. FIG. 5C shows an enlarged end view of the housing portion 208 of the integrated wavelength conversion component 10. In a typical application the integrated wavelength conversion component 10 has a width w (i.e. a dimension in a direction orthogonal the direction of elongation of the component) of about five inches (5″).

The integrated wavelength conversion component 10 is formed as an integrated structure that includes different portions having different physical and/or optical properties. In the embodiment of FIGS. 5A-C, the hollow integrated wavelength component 10 includes a wavelength conversion portion 20, a lower diffuser portion 22a, and an upper portion 22b. In the illustrated embodiment, the wavelength conversion component 10 comprises a profile formed as a continuous wall, where certain portions along the lengths of the wall correspond to the wavelength conversion portion 20, diffuser portion 22a, and upper portion 22b. The continuous wall defines a hollow component having an internal volume 11.

As discussed in more detail below, the wavelength conversion portion 20 comprises one or more photoluminescence materials that produce photoluminescence light in response to excitation from LED light. The wavelength conversion portion 20 is formed as a portion of the wall length of the integrated wavelength conversion component 10 that projects into the hollow interior volume 11 of the integrated wavelength conversion component 10. The wavelength conversion portion 20 therefore forms a projection in a projection direction 13. The shape of the wavelength conversion portion 20 is configured to define an open volume 15, sufficiently large enough to allow insertion of an array of LEDs 21 into that open (hollow) volume 15. The channels 212 for holding the edges of a substrate 160 containing the LEDs 21 and/or heat sink 210 are also integrally formed in the integrated wavelength conversion component 10. FIG. 5C shows an enlarged view of the housing portion 208 of the integrated wavelength conversion component 10. The channels 212 are configured with the appropriate height and width to receive the circuit board 160 having the LEDs 21 and/or heat sink 210, such that the LEDs 21 are located within the volume 15 and face downwards towards the wavelength conversion portion 20 (e.g., as indicated in FIG. 3B).

The upper portion 22b is located along the top of the integrated wavelength conversion component 10, and comprises the wall lengths of the component 10 on either side of the housing 208. The upper portion 22b can be implemented as an optically transparent substrate or lens through which light emitted by the wavelength conversion portion 20 can be emitted in an upwards direction. In the troffer-based lighting arrangement 100, this upwards emission permits emitted light to be directed at (and to widely “fill”) the interior surface of the troffer body 204, and to then be reflected outwards in directions controlled by the configuration of the angled/curved interior of the troffer body 204. This serves to maximize the light coverage by the lighting arrangement 100. Another advantage provided by having the upper portion 22b is that this provides a sealed top to the lamp, which avoids a “bug trap” or “debris trap” problem of having unsightly contaminants intrude within the interior volume 11 of the lamp. In some embodiments, the entire surface of the integrated wavelength conversion component 10 (except for the ends) is formed as a closed surface. Alternatively, a substantial portion of the surface is closed (rather than the entirety of the surface) where openings may be formed in the surface of the integrated wavelength conversion component 10, e.g., where small openings are provided to allow heat exchange from the interior of the component 10. Any suitable material can be used to implement the clear portion 22b. In some embodiment, the upper portion 22b comprises a clear polycarbonate or plastics material.

The diffuser portion 22a is located along the lower portion of the wall lengths of the integrated wavelength conversion component 10. The diffuser portion 22a provides a diffuser that is integrated within the rest of the integrated wavelength conversion component 10. This means that the lighting arrangement 100 does not need to include any other separate diffuser in order to diffuse the light that is emitted from the wavelength conversion portion 20.

The diffuser portion 22a can be configured to include light diffusive (scattering) material. Example of light diffusive materials include particles of Zinc Oxide (ZnO), titanium dioxide (TiO₂), barium sulfate (BaSO₄), magnesium oxide (MgO), silicon dioxide (SiO₂) or aluminum oxide (Al₂O₃). A description of scattering particles that can be used in conjunction with the present invention is provided in U.S. application Ser. No. 14/213,096, filed on Mar. 14, 2014, entitled “DIFFUSER COMPONENT HAVING SCATTERING PARTICLES”, which is hereby incorporated by reference in its entirety.

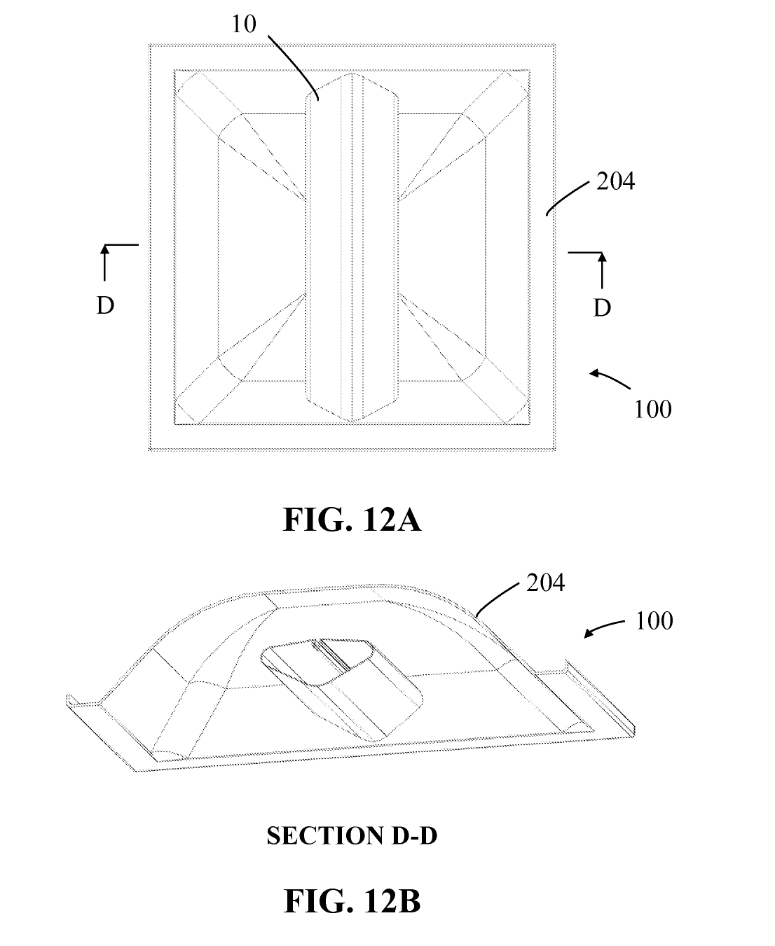

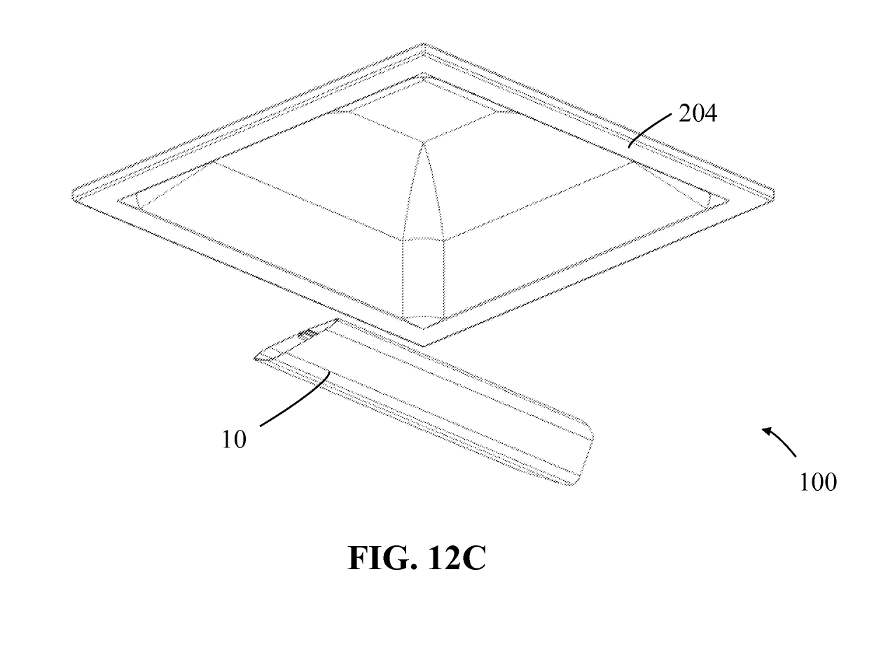

The shape of the diffuser portion 22a contributes greatly to the final emissions characteristics of the lighting arrangement 100. In the embodiment illustrated in FIGS. 5A-C, the integrated wavelength conversion component 10 includes a generally V-shaped lower profile for the diffuser portion 22a. The apex of the V-shape can be relatively rounded (as shown in FIG. 5B) or relatively more angular (as shown in FIG. 12B). This V-shaped profile facilitates light emissions that directs greater amounts of light perpendicularly outwards from the straight linear edge of the V-shape of the diffuser portion 22a. This permits emissions of light from lighting arrangement 100 that are both uniform while also providing a greater amount of coverage area. This allows one to maintain good light coverage with the lighting arrangement even with relatively less lights that need to be installed (since there is relatively greater amounts of light emissions coverage provided by each light and hence greater amounts of spacing can be permitted between the installed lights without loss of lighting performance). The diffuser portion 22a therefore facilitates high efficiency operation of the lamp while avoiding bright centers or spots along the length of the lamp (as would otherwise be the case of the LEDs 21 along the circuit board 160 are made directly visible).

The shape of the wavelength conversion portion 20 can be configured to emit photoluminescence light with any desired emissions characteristics. In some embodiments, the wavelength conversion portion 20 is shaped to more effectively promote the effective distribution of light by the diffuser portion 22a. For example, in the embodiment of FIG. 5A-C, the wavelength conversion portion 20 has a lower generally semi-circular profile that generally and evenly directs photoluminescence light across the surface of the diffuser portion 22a. A lower V-shape profile can also be used for the wavelength conversion portion 20 according to alternate embodiments. It is noted that the wavelength conversion portion 20 is spaced apart from the diffuser portion 22a by the hollow interior volume 11. It will be appreciated that the wavelength conversion portion 20 also substantially reduces bright centers or hot spots along the length of the lamp 9 due to the presence of the photoluminescence material (typically one or more phosphors).

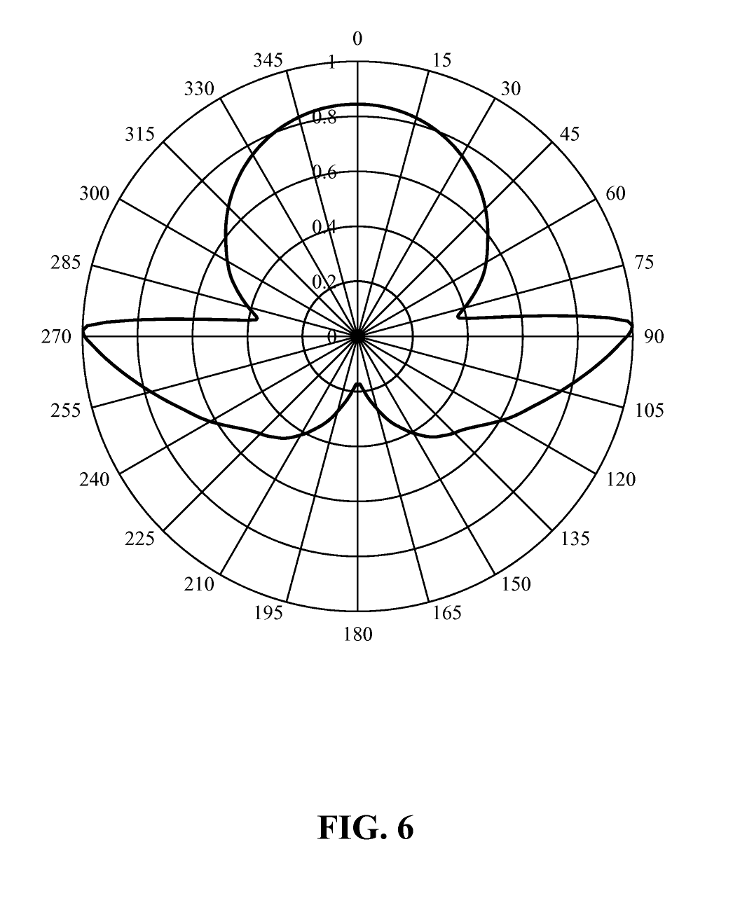

The combination of the clear upper portion 22b and the lower diffuser portion 22a therefore permits separate control of the indirect and direct light patterns emitted by the lighting arrangement 100. The light emitted upwards (indirect emission) through the clear upper portion 22b permits a wide angle, upward emission designed for optimal fill from the arrangement 100. The light emitted downwards (direct emission) through the diffuser portion 22a provides a forward lambertian emission by direct light from the arrangement 100. FIG. 6 is a polar diagram showing the angular emission characteristic of the lighting arrangement 9 illustrating direct and indirect emission components.

The wavelength conversion portion 20 can be formed of and/or include any suitable photoluminescence material(s). In some embodiments, the photoluminescence materials comprise phosphors. For the purposes of illustration only, the following description is made with reference to photoluminescence materials embodied specifically as phosphor materials. However, the invention is applicable to any type of photoluminescence material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths.

The one or more phosphor materials can include an inorganic or organic phosphor such as for example silicate-based phosphor of a general composition A₃Si(O,D)₅ or A₂Si(O,D)₄ in which Si is silicon, O is oxygen, A includes strontium (Sr), barium (Ba), magnesium (Mg) or calcium (Ca) and D includes chlorine (Cl), fluorine (F), nitrogen (N) or sulfur (S). Examples of silicate-based phosphors are disclosed in United States patents U.S. Pat. No. 7,575,697 B2 “Silicate-based green phosphors”, U.S. Pat. No. 7,601,276 B2 “Two phase silicate-based yellow phosphors”, U.S. Pat. No. 7,655,156 B2 “Silicate-based orange phosphors” and U.S. Pat. No. 7,311,858 B2 “Silicate-based yellow-green phosphors”. The phosphor can also include an aluminate-based material such as is taught in United States patents U.S. Pat. No. 7,541,728 B2 “Novel aluminate-based green phosphors” and U.S. Pat. No. 7,390,437 B2 “Aluminate-based blue phosphors”, an aluminum-silicate phosphor as taught in U.S. Pat. No. 7,648,650 B2 “Aluminum-silicate orange-red phosphor” or a nitride-based red phosphor material such as is taught in co-pending United States patent application US2009/0283721 A1 “Nitride-based red phosphors” and International patent application WO2010/074963 A1 “Nitride-based red-emitting in RGB (red-green-blue) lighting systems”. It will be appreciated that the phosphor material is not limited to the examples described and can include any phosphor material including nitride and/or sulfate phosphor materials, oxy-nitrides and oxy-sulfate phosphors or garnet materials (YAG).

Quantum dots can comprise different materials, for example cadmium selenide (CdSe). The color of light generated by a quantum dot is enabled by the quantum confinement effect associated with the nano-crystal structure of the quantum dots. The energy level of each quantum dot relates directly to the size of the quantum dot. For example, the larger quantum dots, such as red quantum dots, can absorb and emit photons having a relatively lower energy (i.e. a relatively longer wavelength). On the other hand, orange quantum dots, which are smaller in size can absorb and emit photons of a relatively higher energy (shorter wavelength). Additionally, daylight panels are envisioned that use cadmium free quantum dots and rare earth (RE) doped oxide colloidal phosphor nano-particles, in order to avoid the toxicity of the cadmium in the quantum dots.

Examples of suitable quantum dots include: CdZnSeS (cadmium zinc selenium sulfide), CdₓZn₁₋ₓ Se (cadmium zinc selenide), CdSeₓS₁₋ₓ (cadmim selenium sulfide), CdTe (cadmium telluride), CdTeₓS₁₋ₓ (cadmium tellurium sulfide), InP (indium phosphide), InₓGa₁₋ₓ P (indium gallium phosphide), InAs (indium arsenide), CuInS₂ (copper indium sulfide), CuInSe₂ (copper indium selenide), CuInSₓSe₂, (copper indium sulfur selenide), CuInₓGa₁₋ₓS₂ (copper indium gallium sulfide), CuInₓGa₁₋ₓSe₂ (copper indium gallium selenide), CuInₓAl₁₋ₓSeₑ (copper indium aluminum selenide), CuGaS₂ (copper gallium sulfide) and CuInS₂ₓZnS₁₋ₓ (copper indium selenium zinc selenide).

The quantum dots material can comprise core/shell nano-crystals containing different materials in an onion-like structure. For example, the above described exemplary materials can be used as the core materials for the core/shell nano-crystals. The optical properties of the core nano-crystals in one material can be altered by growing an epitaxial-type shell of another material. Depending on the requirements, the core/shell nano-crystals can have a single shell or multiple shells. The shell materials can be chosen based on the band gap engineering. For example, the shell materials can have a band gap larger than the core materials so that the shell of the nano-crystals can separate the surface of the optically active core from its surrounding medium. In the case of the cadmiun-based quantum dots, e.g. CdSe quantum dots, the core/shell quantum dots can be synthesized using the formula of CdSe/ZnS, CdSe/CdS, CdSe/ZnSe, CdSe/CdS/ZnS, or CdSe/ZnSe/ZnS. Similarly, for CuInS₂ quantum dots, the core/shell nanocrystals can be synthesized using the formula of CuInS₂/ZnS, CuInS₂/CdS, CuInS₂/CuGaS₂, CuInS₂/CuGaS₂/ZnS and so on.

In many electrical devices, the portion of the device that houses the power electronics must be configured to provide the proper amount safety-related protection to consumers from any accidental failures of the electronic components. This type of safety-related configuration is often required for the product design in order to obtain certification from various certification bodies. In conventional lighting devices, the design of the housing typically forces a substantial amount of excess materials, complexity, and additional components to be added to the overall design of the product.

In contrast, the design of the present embodiments permits a more compact and efficient design that more efficiently isolates the electrical portions of the arrangement. Here, the electrical portions of the lamp (the circuit board 160 having the LEDs 21 is fully contained within the housing portion 208) and is further electrically isolated in either end via the end caps 29 to the power supply 200 and the enclosure 202. There are no additional wiring structures or conduits required through any part of the troffer body 204. This inherent electrical isolation through a very compact space permits the embodiments of the invention to generally require only a relatively small portion of the lamp at or within the housing portion 208 to require any special requirements for dimensions and/or materials (if necessary at all) to meet certification requirements, potentially allowing the rest of the lamp to be formed with less stringent requirements for dimensional thicknesses and/or specific materials. This can reduce the overall cost, weight, and complexity of the design or the lamp.

Therefore, the isolation of the electrical components to the single compact portion through the integrated wavelength conversion component 10 (rather than through a troffer body) allows for the troffer body 204 to be configured with a much lighter and cheaper material composition (e.g., a plastic reflector material). This results in much lower costs, easier manufacturing, and lowered final weight for the lighting arrangement.

In some embodiments, the linear integrated wavelength conversion component 10 combined with the heat sink 210 and/or circuit board 160 can constitute an approved electrical enclosure of the troffer-based lighting arrangement. One end of the LED-based linear lamp 9 shares an electrical enclosure with the power supply such the power supply and integrated wavelength conversion component house all electronics in the lighting arrangement, allowing the troffer body 204 to be a passive reflector with no electrical requirements or enclosure. In some embodiments, the total weight of the plastic troffer-based lighting arrangement is less than 6 lbs for a 2′×2′ (two feet by two feet) troffer and less than 12 lbs for a 2′×4′ (two feet by four feet) troffer of which greater than 70% is plastic.

The LED-based linear lamp 9 of the present invention also provides numerous advantages over conventional fluorescent linear lamps. Unlike fluorescent lamps, LED-based linear lamps do not require any mercury. In addition, LED-based lamps are able to generate higher lumens per wattage as compared to fluorescent lamps, while having lower defects rates and higher operating life expectancies.

It is noted that the integrated nature of the integrated wavelength conversion component 10 also provides numerous advantages. Integrating the wavelength conversion portion 20 with an enclosure having other portions (such as the diffuser portion 22a) that forms a unitary component avoids many problems associated with having them as separate components. With the present invention, the integrated component can be assembled without requiring components for these functional portions, and without requiring separate assembly actions to place them into a lighting arrangement. In addition, significant material cost savings can be achieved with the present invention. The overall cost of the integrated wavelength conversion component 10 is generally less expensive to manufacture as compared to the combined costs of having a separate wavelength conversion component and a separate diffuser component. In addition, separate packaging costs would also exist for the separate component. Moreover, an organization may incur additional administrative costs to identify and source the separate components. By providing an integrated component that integrates the different portions together, many of these additional costs can be avoided. However, in some alternate embodiments, the wavelength conversion component 10 does not need to be manufactured as an integrated component. For example, the wavelength conversion portion 20 may be separately manufactured, and then affixed to a hollow component having only lower and upper portions 22a and 22b. In this approach, the hollow component may provide an opening at the center top surface or it may alternatively have a closed surface at the top.

The present invention also provides better light emission characteristics for the troffer-based lighting arrangement 100. This is particularly advantageous since the lighting arrangement 100 allows for both upper (indirect) and lower (direct) light emissions from the integrated component 10. The design of the present embodiment is particularly unique, given the “floating” nature of the indirect/direct sealed optical element placed in the interior and/or center of the component (not against a reflector wall). In addition, the troffer design can be simplified, since a separate diffuser and panel/door are no longer needed and a socket is not needed for fluorescent tubes.

According to some embodiments, a troffer-based lighting arrangement comprises a single linear solid-state light source or array of sources on a single linear PCB located within 20% of the center of the fixture (troffer body) in both the horizontal and vertical directions. The linear light source is attached to a tubular optical element greater than two inches (2″) in width that includes a diffuser surface substantially facing in the direction of light emission. The linear light source combined with the tubular linear optical element provides both direct and indirect emission of at least 25% in both the upward and downward directions.

In one embodiment, a single walled molded troffer body is provided that corresponds to greater than 95% reflectivity that is made of plastic or similarly formed non-ferrous material. In some embodiments, the troffer provides at least 25% of the total light coming from indirect reflection off of the reflective body and at least 25% of emission coming from direct emission from the forward facing diffuser attached to the linear light source.

The advanced design of the invention therefore provides for better light uniformity, high reliability, and improved performance, while at the same time allowing for lower costs, less complexity, lower weight requirements, and much improved assembly efficiencies.

In certain circumstances, there may be limitations imposed upon the ability to use a troffer body that is formed of plastic. For example, regional fire codes may require the use of metal for certain fire-rated, commercial installations.

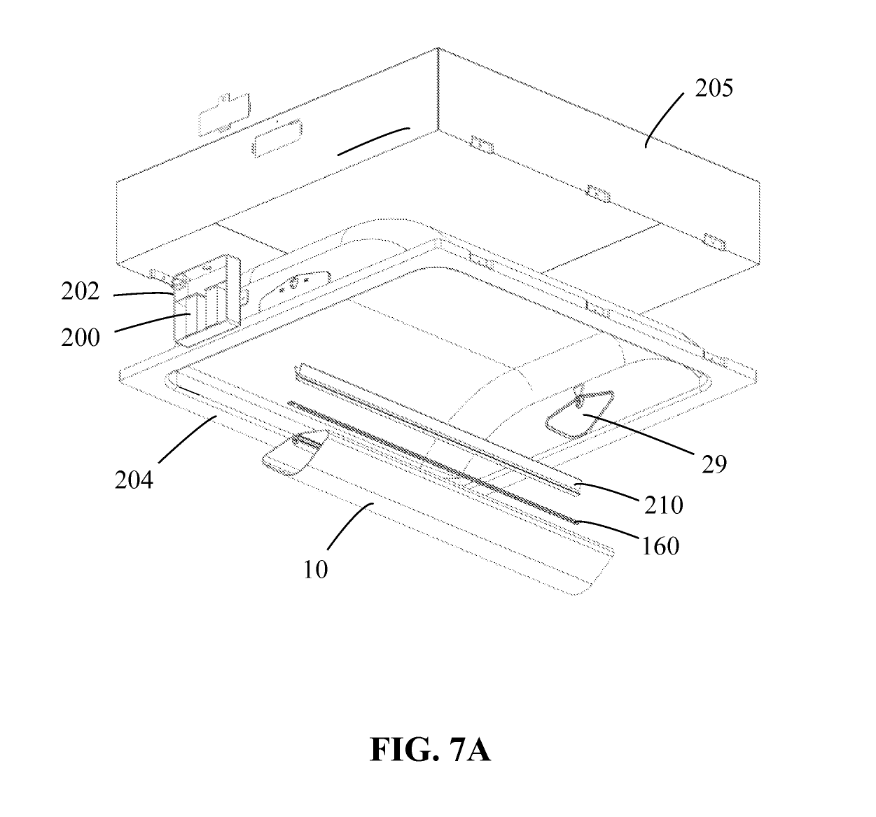

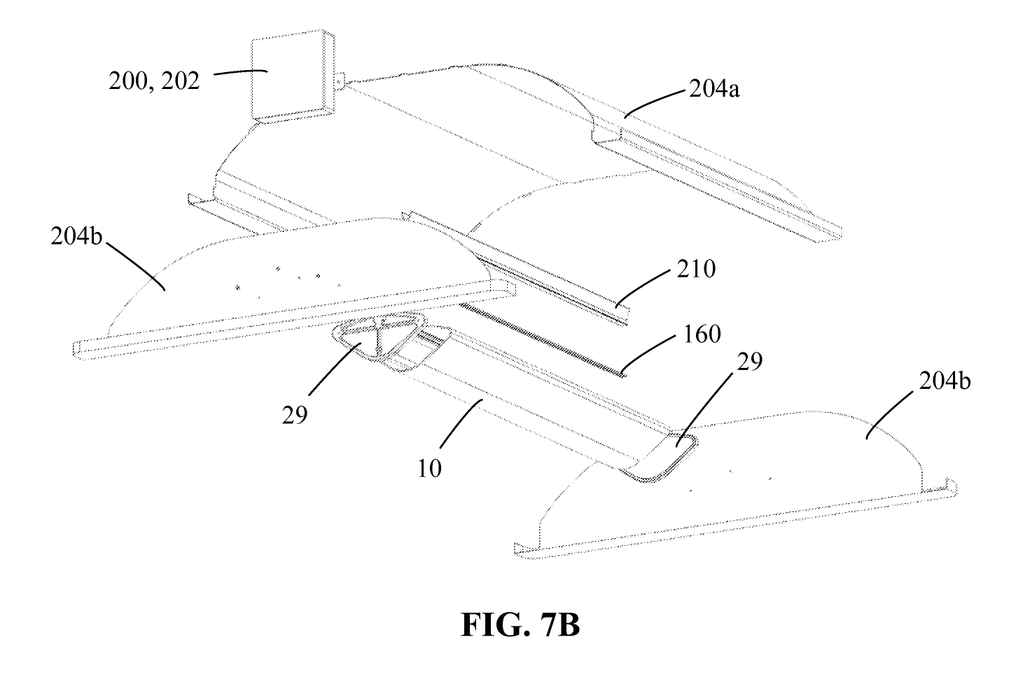

FIG. 7A illustrates a first example approach to address the situation where metal is required for a lighting installation. In this approach, the lighting arrangement uses a troffer body 204 formed of plastic as described above. However, a metal enclosure 205 (e.g., a steel enclosure) is provided to be used in conjunction with the plastic troffer body 204. The plastic troffer body 204 is enveloped by the metal enclosure 205 to at least the extent sufficient to satisfy any required regional building codes.

FIG. 7B illustrates another approach that can be taken to address this issue. In this approach, the troffer body 204 is now formed of a metal material (instead of plastic) to satisfy any required building codes. As shown in FIG. 7B, the troffer body may be manufactured from multiple sheet metal components 204a and 204b, including a center sheet metal frame 204a, a left sheet metal end 204b, and a right sheet metal end 204b. These sheet metal frames are assembled together to form the troffer body.

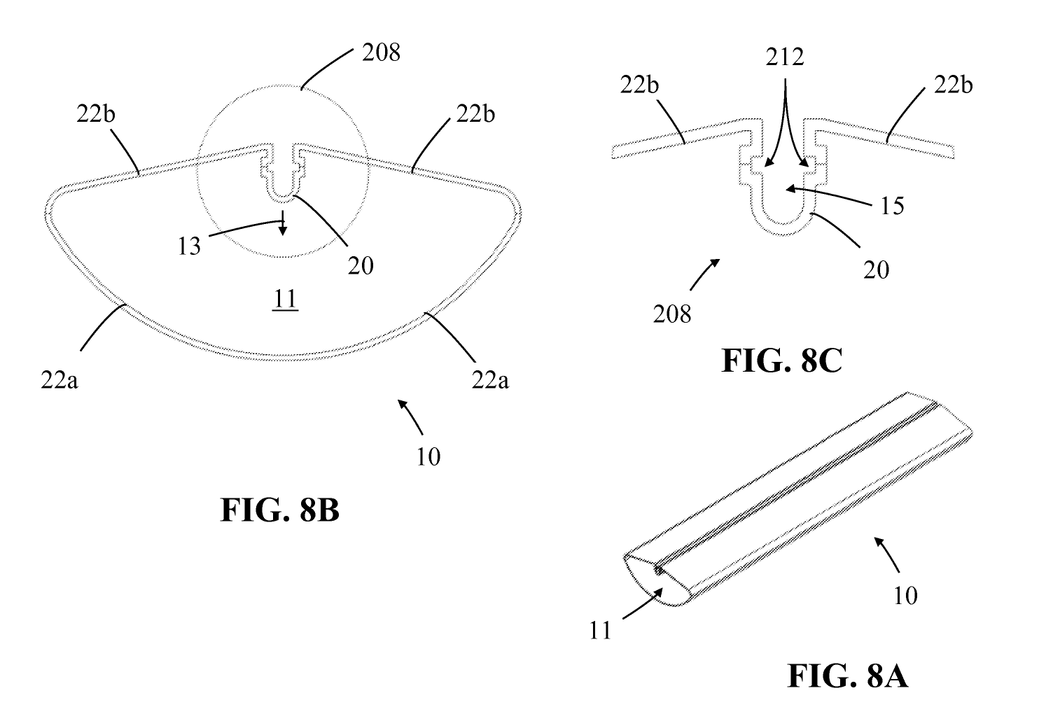

The integrated wavelength conversion component 10 can be shaped into any configuration as needed to fulfill an intended application of the invention. FIGS. 8A-C illustrate an alternative embodiment of the invention where the integrated wavelength conversion component 10 has a diffuser portion 22a that has a more rounded profile for the lower portion. The rounded profile of the current embodiment promotes greater amount of the emitted light to be directed directly underneath the lighting apparatus, at least as compared to the less-rounded shape of the earlier embodiment of FIGS. 5A-C.

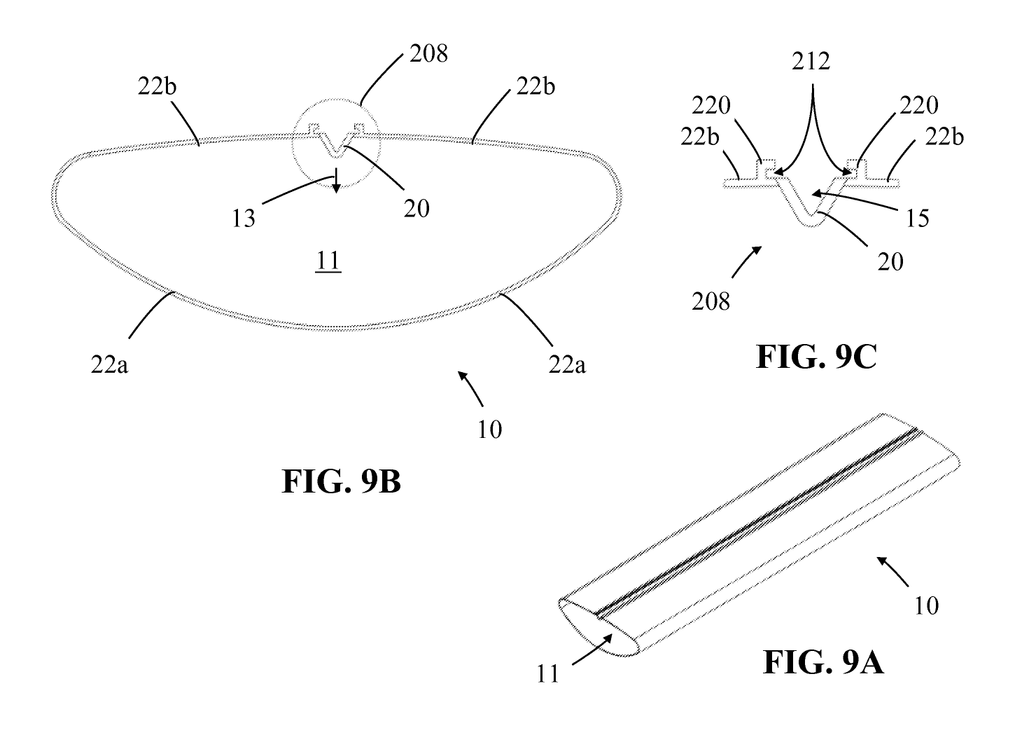

FIGS. 9A-C illustrate another embodiment of the integrated wavelength conversion component 10. Here, the housing portion 208 differs from the earlier embodiments in that it includes protrusions 220 to define the recesses 212. This differs from the earlier embodiments in several distinct ways. First, the protrusions 220 in FIG. 9C protrude from the exterior of the integrated wavelength conversion component 10, rather than being integrated into the flow of the wall length of the component 10 like the embodiments shown in FIGS. 5A-C and 8A-C. This is significant since these protrusions can make it more difficult to manufacture the component 10 using certain manufacturing techniques, such as vacuum-based extrusions processes. In addition, the positioning of the protrusions 220 causes the recesses 212 to be exterior to the enclosure of the integrated wavelength conversion component 10. This means that the circuit board 160 that slides into the recesses 212 will be outside of the enclosure profile formed by the shape of the integrated wavelength conversion component 10, which differs from the embodiments shown in FIGS. 5A-C and 8A-C where the circuit board 160 once inserted is inside the enclosure profile of the component 10. In addition, the LEDs 21 that are inserted into space 15 formed by the wavelength conversion portion 20 will be located closer to the exterior of the component 10, differing from the approaches shown in FIGS. 5A-C and 8A-C where the LEDs 21 are positioned further into the interior of the component 10.

As is clear, the integrated wavelength conversion component 10 can be formed into any suitable shape. The above-described embodiments each pertain wavelength conversion components 10 having a non-cylindrical shape (i.e. non-circular profile). It is noted, however, that alternate embodiments may include lamps where the integrated wavelength conversion component 10 forms a substantially cylindrical shape, e.g., for embodiments of the invention to be placed into existing lighting troffers/fixtures designed for of traditional fluorescent tube shapes.

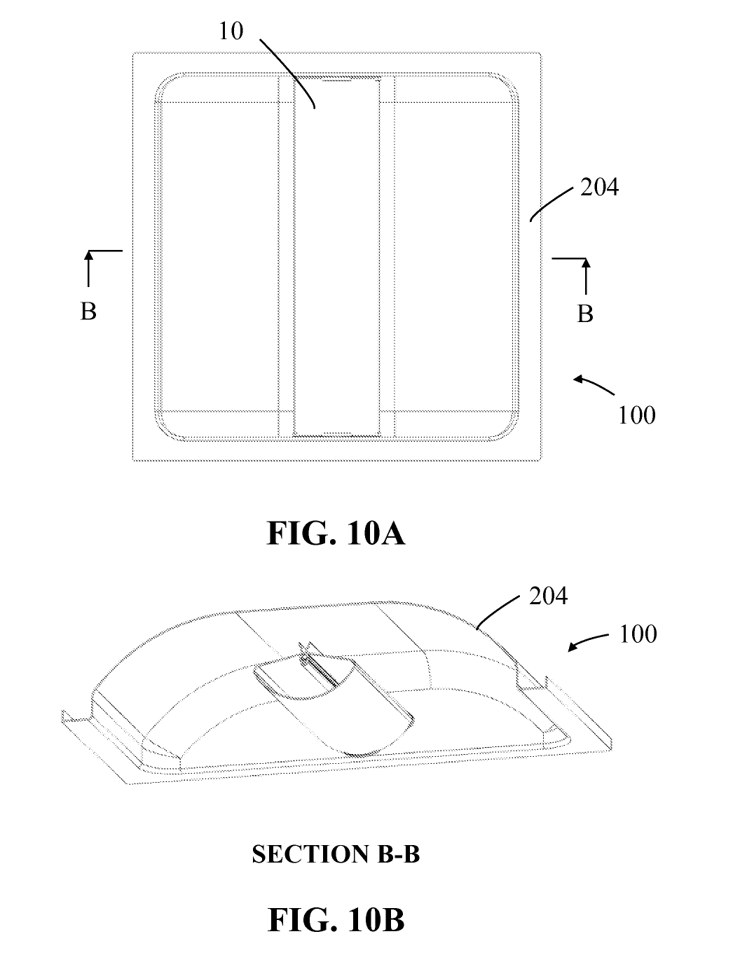

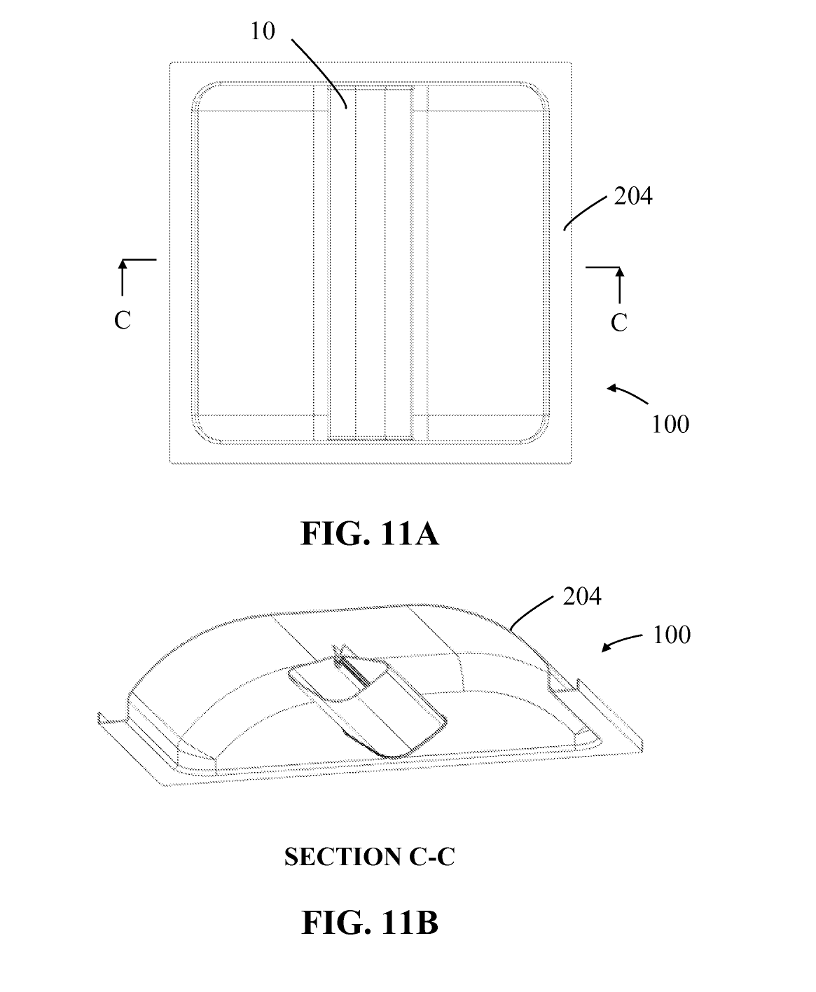

FIGS. 10A-B, 11A-B, and 12A-C illustrate examples of different combinations that can be configured for the troffer body 204 and integrated wavelength conversion component 10. FIG. 10A-B illustrate an integrated wavelength conversion component 10 having a rounded lower profile that is inserted into a troffer body 204. FIGS. 11A-B illustrate an integrated wavelength conversion component 10 having a generally V-shaped lower profile that is inserted into a troffer body 204.

The approach of FIGS. 12A-C also includes an integrated wavelength conversion component 10 having a generally V-shaped lower profile. However, the difference between this embodiment and the earlier embodiments is that the interior walls of the troffer body 204 are curved throughout the troffer body. This means that the ends of the integrated wavelength conversion component 10 are sloped/curved to match the curved shape of the interior walls of the troffer body 204. This configuration is different from the approach of FIGS. 10A-B and 11A-B, where the end walls of the troffer body 204 are perpendicular rather than curved, which means that the ends of the integrated wavelength conversion component 10 in these embodiments do not need to be sloped/curved.

It is noted that the invention is not limited to the exemplary embodiments described and that numerous other variations can be made within the scope of the invention. For example, the integrated wavelength conversion component 10 of the present invention can be used in numerous other lighting contexts, and is not to be limited in its usefulness only to troffer-based lighting arrangements.

### Pendant Lighting Arrangements

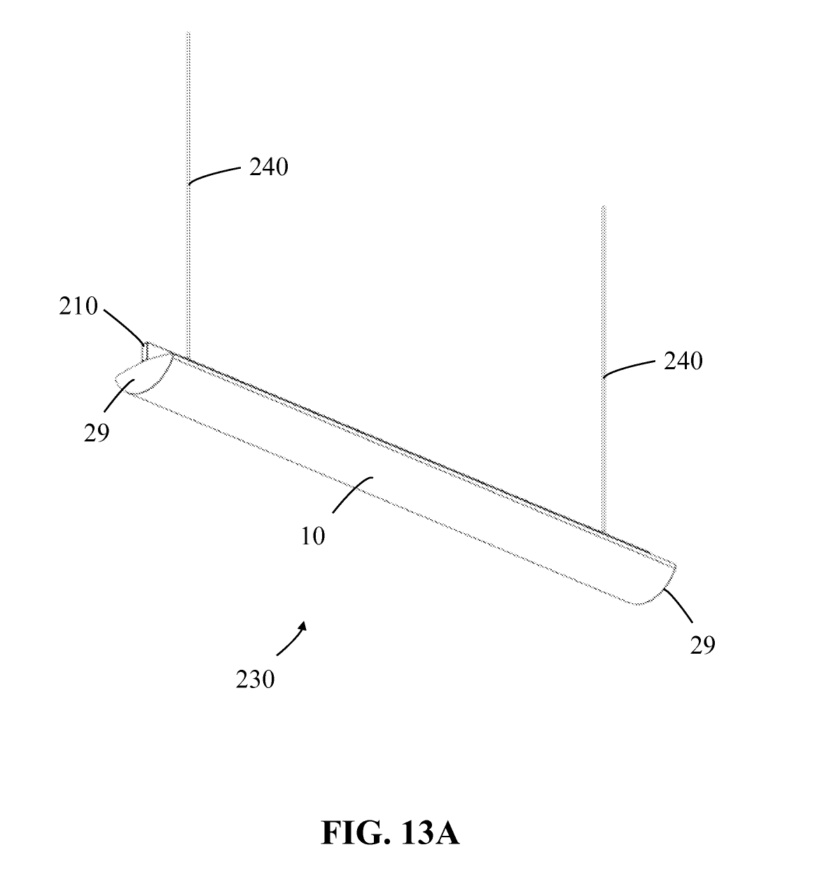

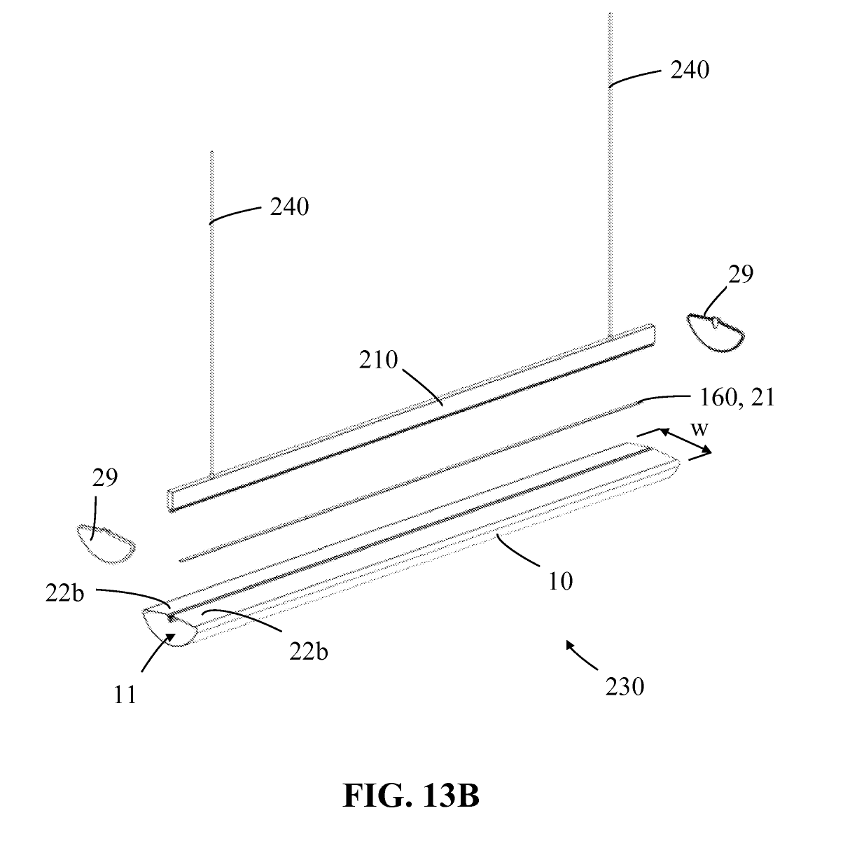

FIGS. 13A-B illustrates an embodiment of the invention in which the integrated wavelength conversion component 10 is used to form a pendent lighting arrangement (lamp) 230. Here, the integrated wavelength conversion component 10 is suspended from a ceiling using suspension structures 240, e.g., support rods or cables attached to a heat sink support structure 210. This application of the component 10 is feasible due to the integrated nature of the component 10, since no additional components are needed to provide a diffuser or support structure for the LEDs/circuit board. It is envisioned that in a typical application the integrated wavelength conversion component 10 has a width w (i.e. a dimension in a direction orthogonal the direction of elongation of the component FIG. 13B) of about five inches (5″).

Since a troffer body does not need be included in this pendant lamp application, there is no need for light to be emitted from the top portion of the pendant lamp 230. In such embodiments therefore, the top portion 22b of the component does not need to be formed of a clear material. Instead, the top portion 22b can be formed as a reflector portion. In this embodiment, the reflector portion can comprise a light reflective material, e.g., a light reflective plastics material. Alternatively the reflector can comprise a metallic component or a component with a metallization surface. In other embodiments the top portion 22b can be formed of a light transmissive material (e.g., optically clear or light diffusive) where it is desired to provide a degree of illumination of a ceiling.

In other pendant lighting arrangements the top portion 22b can emit light to illuminate the ceiling. As is known the spacing of pendant lamps and/or troffers are selected to ensure a uniform illumination at for example a work station height within the environment. Typically, pendant lamps and troffers are located on a fixed grid pattern, for example spaced eight feet apart to ensure such a uniform illumination at the work station height. Where it is required to provide at least a degree of ceiling illumination, it is desirable that such illumination is also uniform over the ceiling. Since the distance from the pendant lamp to the ceiling is typically shorter than the distance from the pendant lamp to the working height, this requires the top portion 22b to have a wider emission characteristic than that of the lower diffuser portion 22a to ensure a uniform illumination of both ceiling and work area. Such differing emission characteristics can be achieved by selection of the shape and/or degree of diffusivity of the upper portion 22b and diffuser portions 22a.

Alternative embodiments may employ white LEDs, where the photoluminescence material is provided in a material that directly encapsulates the LED chip. Since the photoluminescence material is provided as part of the structure of the LED chip 21 on the substrate 160, this means that portion 20 in the integrated component 10 does not need to include photoluminescence material. Instead, the materials used to form portion 20 can be made of a transparent material, e.g., a clear polycarbonate or other plastics material or a light diffusive material. This approach differs from to the previously-described embodiments where the LED chip 21 does not itself include photoluminescence material, but instead are configured as remote phosphor applications where the photoluminescence materials in portion 20 are spaced apart from the LEDs 21.

In yet another embodiment, photoluminescence material can be included in both an encapsulant for the LEDs 21 as well as in portion 20. This embodiment is useful, for example, to provide more expensive phosphor materials (such as red phosphors) in the encapsulant for the LEDs while including less expensive phosphor materials (such as green or yellow phosphors) in the portion 20. The advantage of this configuration is that much less phosphor material needs to be placed in the relatively smaller volume of the encapsulant that surrounds the LEDs 21, at least as compared to the amount of phosphor materials that would otherwise need to be placed into the much greater volume of the portion 20 of the component 10.

This approach can also be taken if there is a need to use certain phosphor materials that may be excessively vulnerable to possible damage from the extrusion/molding process used to form the integrated component 10. If such phosphor materials need to be used, then they can be placed into the encapsulant for the LED chips 21 rather than placed within the integrated component 10.

In embodiments where the integrated component has a constant cross section, it can be readily manufactured using an extrusion method. Some or all of the integrated component can be formed using a light transmissive thermoplastics (thermosoftening) material such as polycarbonate, acrylic or a low temperature glass using a hot extrusion process. Alternatively some or all of the component can comprise a thermosetting or UV curable material such as a silicone or epoxy material and be formed using a cold extrusion method. A benefit of extrusion is that it is relatively inexpensive method of manufacture.

A co-extrusion approach can be employed to manufacture the integrated component. Each of the top portion 22b, wavelength conversion component 20, and diffuser portion 22a are co-extruded using respective materials appropriate for that portion of the integrated component. For example, the wavelength conversion portion 20 is extruded using a base material having photoluminescence materials embedded therein. The diffuser portion 22a can be co-extruded to include diffusion particles. The top portion 22b can be co-extruded using any suitable material, e.g., a light transmissive thermoplastics by itself or thermoplastics that includes light diffusive or light reflective materials embedded therein.

A triple-extrusion process can be utilized to manufacture the integrated component 10, where three extruders are used to feed into a single tool to create the layer of phosphor portion, the materials of the top portion, and the material of the diffuser portion. The three layers are simultaneously created and manufactured together in this approach.

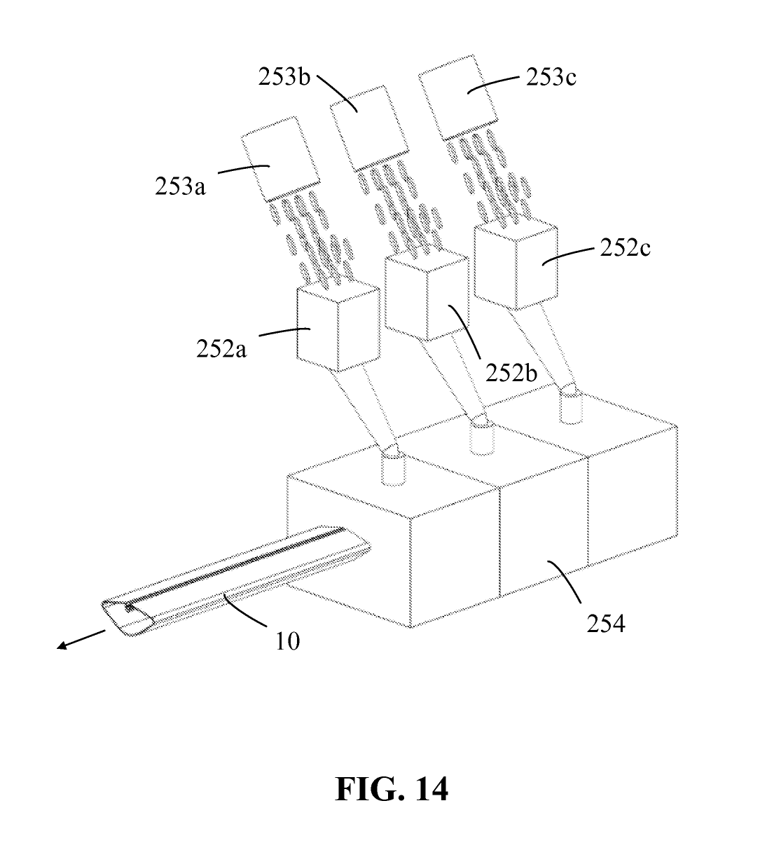

FIG. 14 illustrates this process for co-extruding the integrated wavelength conversion component 10. In this approach, multiple extruders 252a-c feed into a single extrusion head 254 to create the integrated wavelength conversion component 10. This approach can be used with a wide variety of source materials, e.g. PC-Polycarbonate, PMMA-Poly(methyl methacrylate), and PET-Polyethylene Terephthalate, including most or all thermoform plastics. This co-extrusion process can generally use pellets identical or similar to pellets used for injection molding materials.

A first extruder 252a processes a first material 253a for the diffuser portion 22a of the integrated wavelength conversion component 10. As previously noted, a light diffusing/scattering material can be incorporated into the material to form the diffuser portion. Therefore, the first extruder 252a can be used to process a polymer material 253a that includes the light diffusing/scattering material. In some embodiments, the light reflective material comprises titanium dioxide (TiO₂) though it can comprise other materials such as barium sulfate (BaSO₄), magnesium oxide (MgO), silicon dioxide (SiO₂) or aluminum oxide (Al₂O₃).

A second extruder 252b processes a second material 253b for the phosphor portion 20 of the integrated wavelength conversion component 10. Therefore, the second extruder 252b can be used to process a polymer material that also includes the phosphor material.

A third extruder 252c processes a third material 253c for the top portion 22b of the integrated wavelength conversion component 10. The third extruder 252c is used to process a clear solid material (e.g., clear polymer).

The extruders 252a-c are used to feed their respective materials 253a-c into a single extruder head 254 to create the multiple portions of materials in the integrated wavelength conversion component 10. The final product is the integrated wavelength conversion component 10, where the various phosphor portion 20, diffuser portion 22a, and clear portion 22a are shaped as illustrated in FIG. 5B.

In some embodiments, a heat sink can be integrally formed into the integrated wavelength conversion component 10. In this approach, material for the heat sink is provided to the extrusion head by a separate extruder, and the heat sink material is used to extrude the portion of the component 10 adjacent to the intended location of the circuit board having the LEDs. Any suitable material may be used as the heat sink material, so long as the material has sufficient thermal conductance properties adequate to handle the amounts of heat to be generated by the specific lighting application/configuration to which the invention is directed. For example, thermally conductive plastics or polymers having thermally conductive additives may be used as the source material for the extruder that forms the heat sink portion of the component 10. The integrally formed heat sink may be used to avoid the need to add an external heat sink during the manufacturing process for the lamp. Alternatively, the integrally formed heat sink may be used in conjunction with an external heat sink.

Different types of extrusion processes may be used to manufacture the integrated wavelength conversion component 10. In some embodiments, a vacuum extrusion approach is performed to manufacture the integrated wavelength conversion component 10. The vacuum extrusion approach is preferable when manufacturing the embodiments of FIGS. 5A-C and 8A-C, since these embodiments do not include any protrusions that extend from the surface of the integrated wavelength conversion component 10.

The inventive concepts disclosed herein are not limited in their application only to lighting arrangements involving pendent-based lamps or troffer-based lamps mounted in a suspended ceiling. In fact, the invention can be applied to a broad range of applications beyond just pendent-based and troffer-based lighting arrangements. For example, consider the typical garage, workshop, or other space that needs lighting but where the space does not have a suspended ceiling to fit a troffer-based arrangement and/or it is impractical to use a pendent-based lighting arrangement. In this situation, it is often desirable to use a surface mounted arrangement to provide lighting for the space.

### Surface Mountable Linear Lighting Arrangements

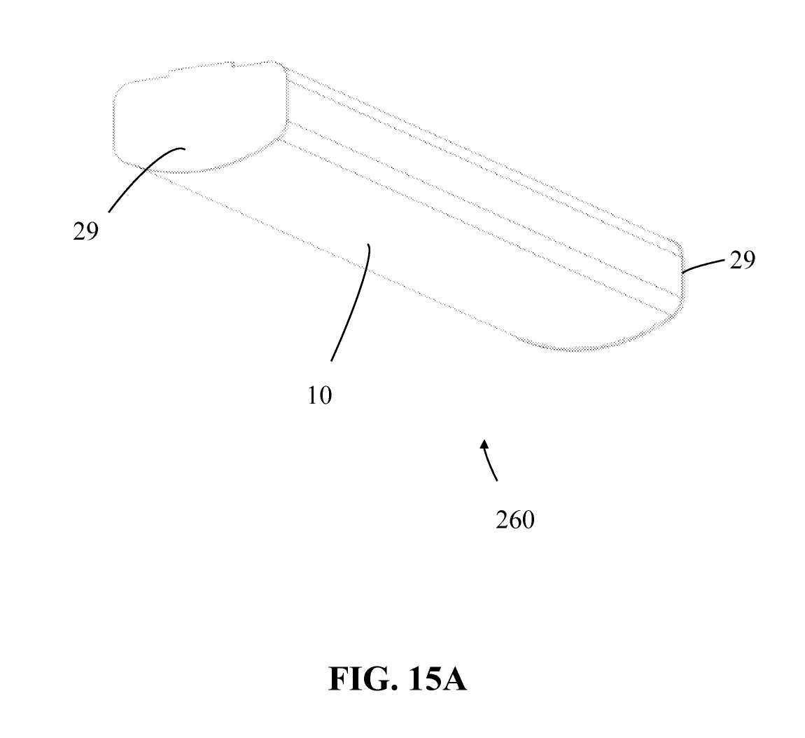

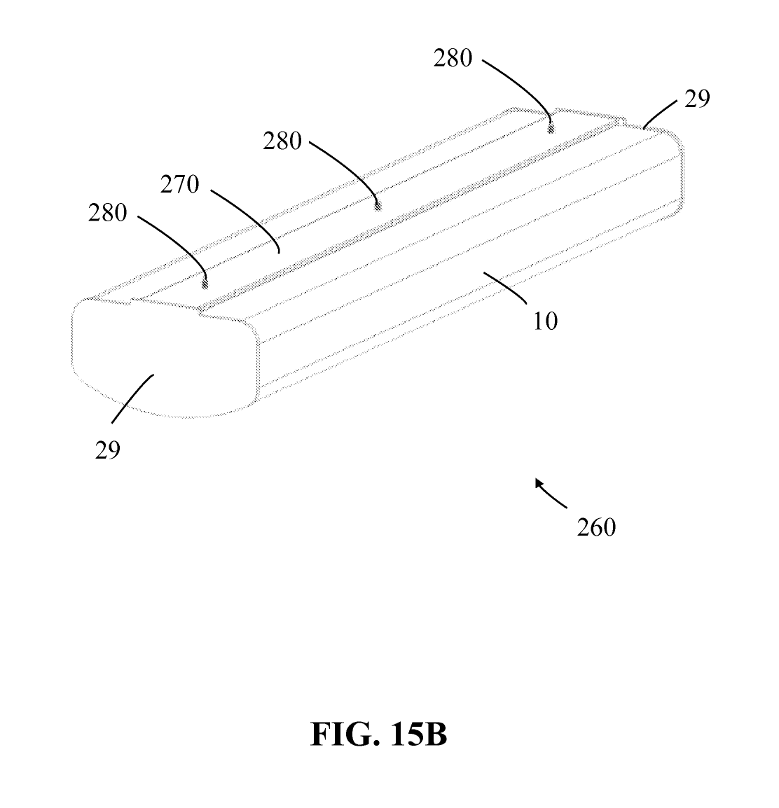

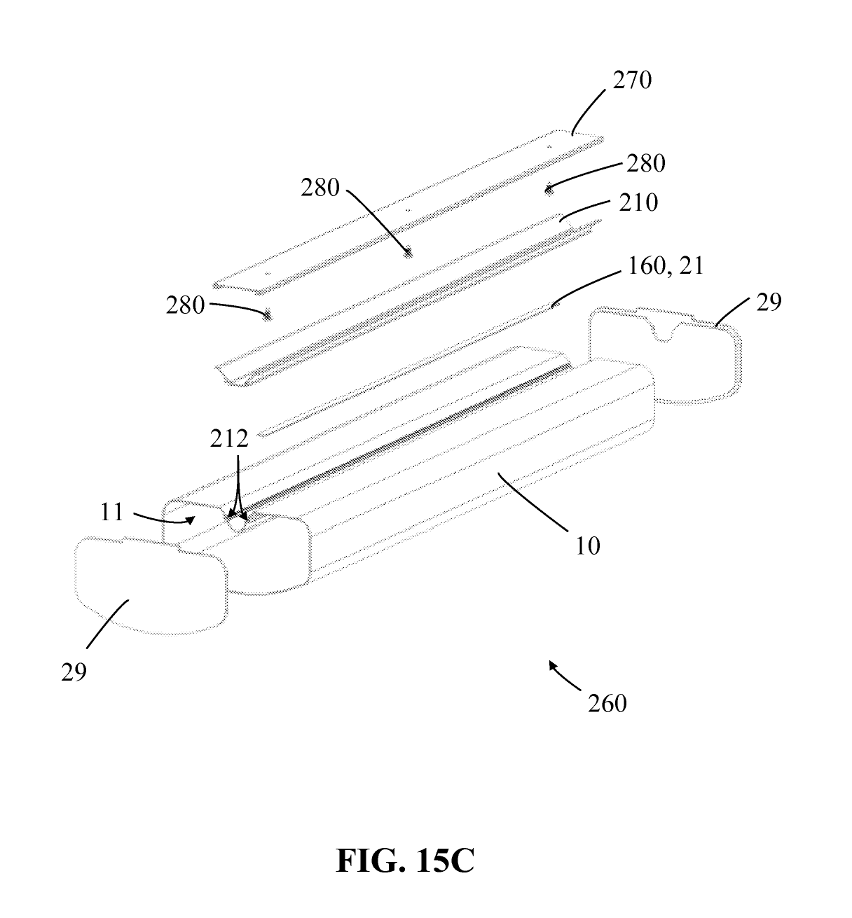

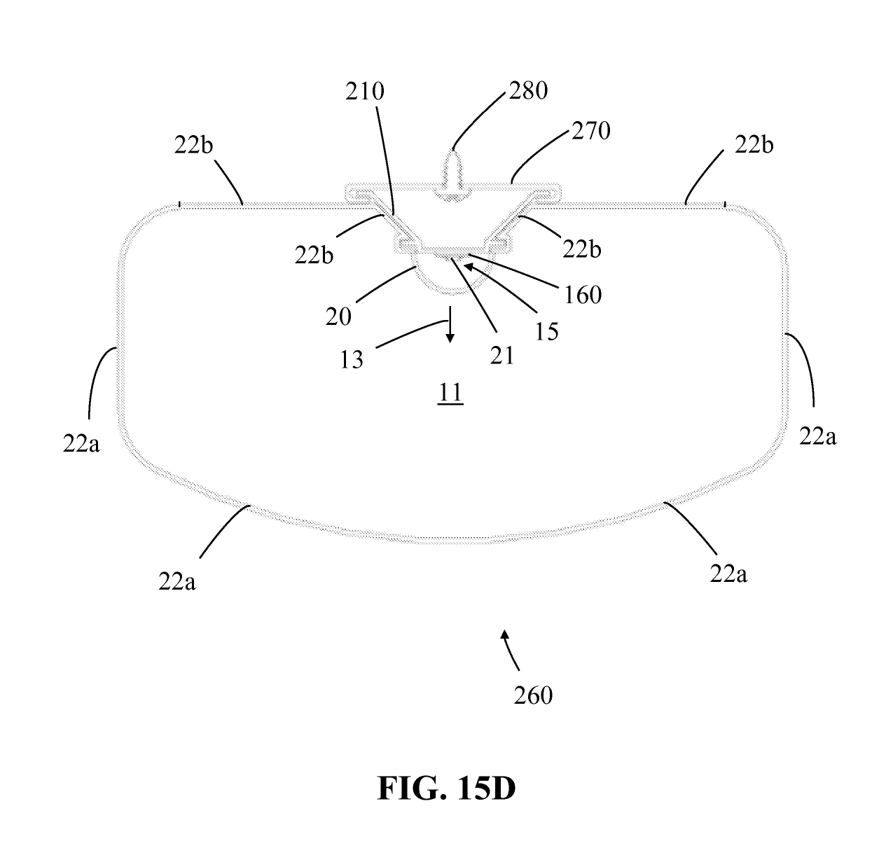

FIGS. 15A-D illustrate a surface mountable wraparound linear lighting arrangement 260 according to embodiments of the invention. The surface mountable lighting arrangement 260 includes an integrated wavelength conversion component 10, which is similar to the previous embodiments in that it includes a wavelength conversion portion 20 having one or more photoluminescence materials which absorb a portion of the excitation light emitted by the LEDs 21 and re-emit light of a different color. The integrated wavelength conversion component 10 includes a diffuser portion 22a that is integrally formed into the component 10 (FIG. 15D).

The lighting arrangement 260 further includes wavelength conversion component end caps 29, a substrate 160, a heat sink 210, and a mounting plate 270. The substrate 160 contains an array of LEDs 21 and is affixed to the heat sink 210. The component 10 includes slots 212 to receive the substrate 160 and/or the heat sink 210. In some embodiments, both the circuit board 160 and the heat sink 210 are mounted within the component 10, by inserting the edges of the circuit board 160 and the heat sink 210 along and through the slots 212. In this embodiment, the combined thickness of the substrate 160 and the base of the heat sink 210 is configured to fit within the height of the slots 212. The heat sink 210 therefore extends along the entire length of the integrated wavelength component 10 adjacent to the circuit board 160. In an alternate embodiment, only the heat sink is mounted within the component 10 through the slots 212. In this alternate embodiment, the substrate 160 is separately mountable to the heat sink 210, e.g., using an adhesive or adhesive tape.

A mounting plate 270 is used to mount the lighting arrangement 260 to a ceiling, e.g., using fixing screws 280. The mounting plate can be formed of any suitable material such as an extruded aluminum section or an extruded thermoplastics material. Channels are formed along the opposing lateral edges of the mounting plate 270. The heat sink 210 can be attached to the mounting plate 270 by sliding the edge portion of the heat sink 210 into the channels on the mounting plate 270. If the heat sink is formed from a rigidly deformable material, then the edges of the heat sink 210 can also be snapped into the channels of the mounting plate 270.

As before, the integrated wavelength conversion component 10 is formed as an integrated structure that includes different portions having different physical and/or optical properties. The integrated wavelength component 10 includes a wavelength conversion portion 20, a diffuser portion 22a, and an upper portion 22b, where the wavelength conversion component 10 comprises a profile formed as a continuous wall, and certain portions along the lengths of the wall correspond to the wavelength conversion portion 20, diffuser portion 22a, and upper portion 22b.

Similar to the previously described embodiments, the integrated wavelength conversion component 10 includes a top portion 22b. However, since the lighting arrangement 260 is intended for a surface mounted application, there is little or no need for light to be emitted from the top portion of the lamp 260. Therefore, the top portion 22b of the component does not need to be formed of a clear material, but is instead formed as a light reflective portion. The light reflective portion can comprise a light reflective material, e.g., a light reflective plastics material. Alternatively the reflector can comprise a metallic component or a component with a metallization surface.

The diffuser portion 22a provides a diffuser that is integrated within the rest of the integrated wavelength conversion component 10. This means that the lighting arrangement 100 does not need to include any other separate diffuser in order to diffuse the light that is emitted from the wavelength conversion portion 20. The shape of the diffuser portion 22a contributes greatly to the final emissions characteristics of the lighting arrangement 260. Unlike the previously described embodiments, the current embodiment of the component 10 is configured such that diffuser portion 22a includes both a curved lower portion and relatively vertical side portions.

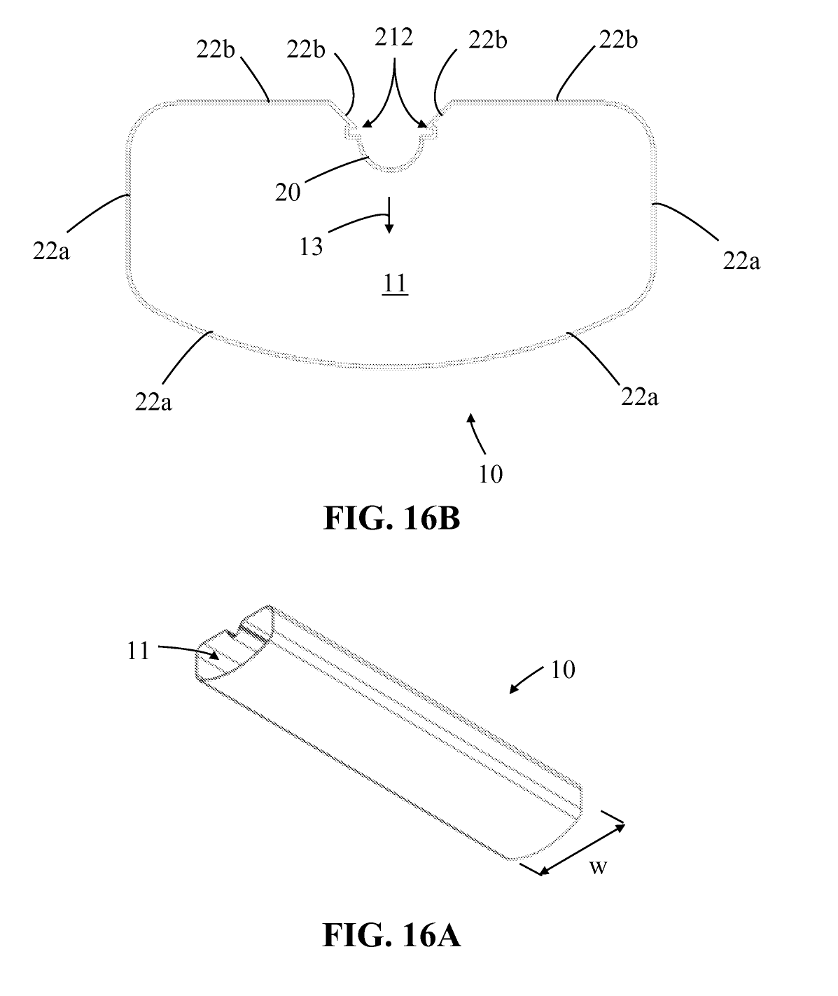

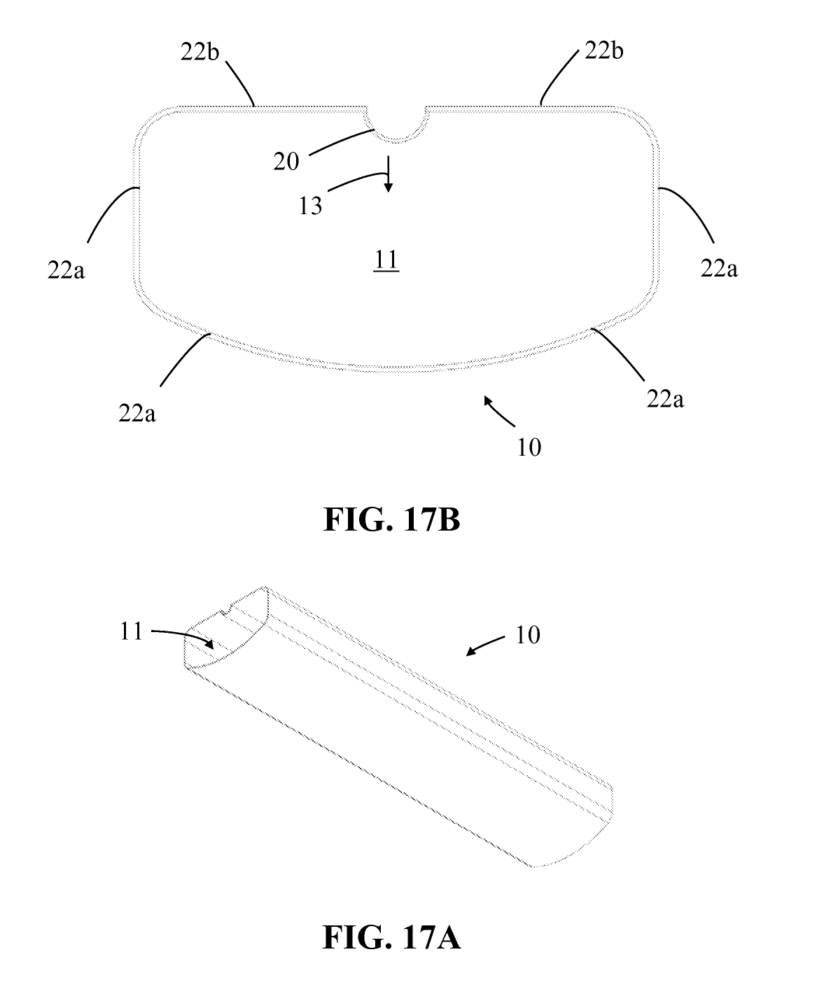

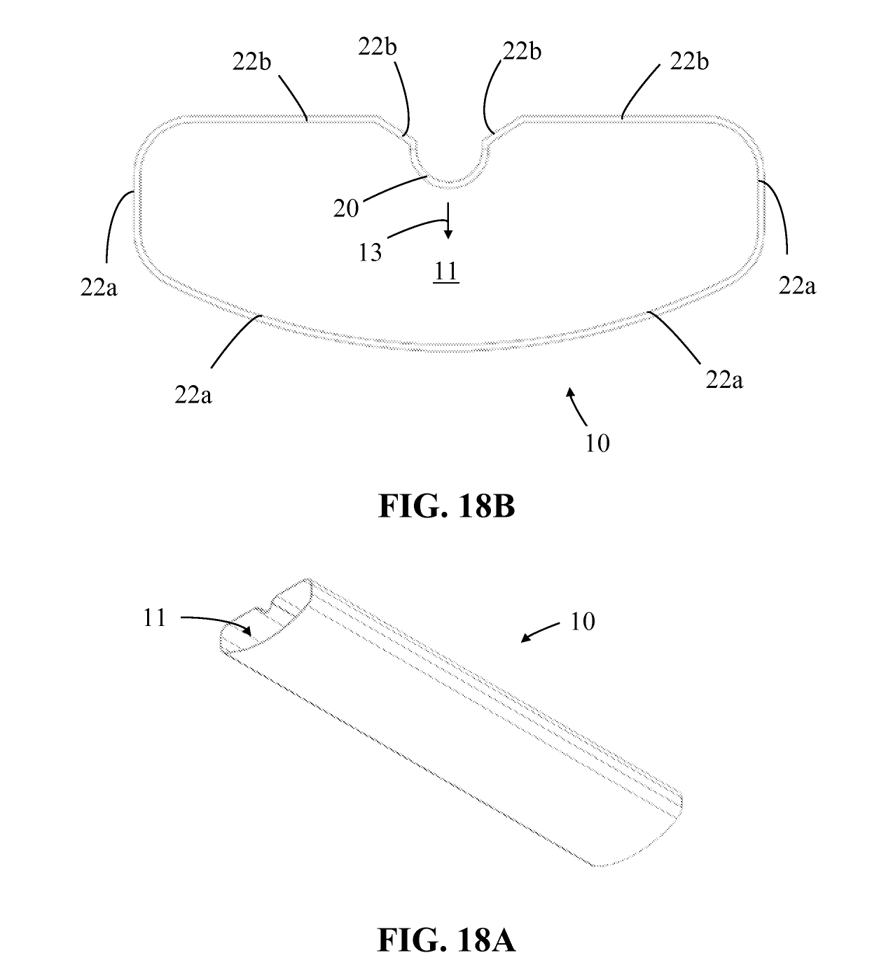

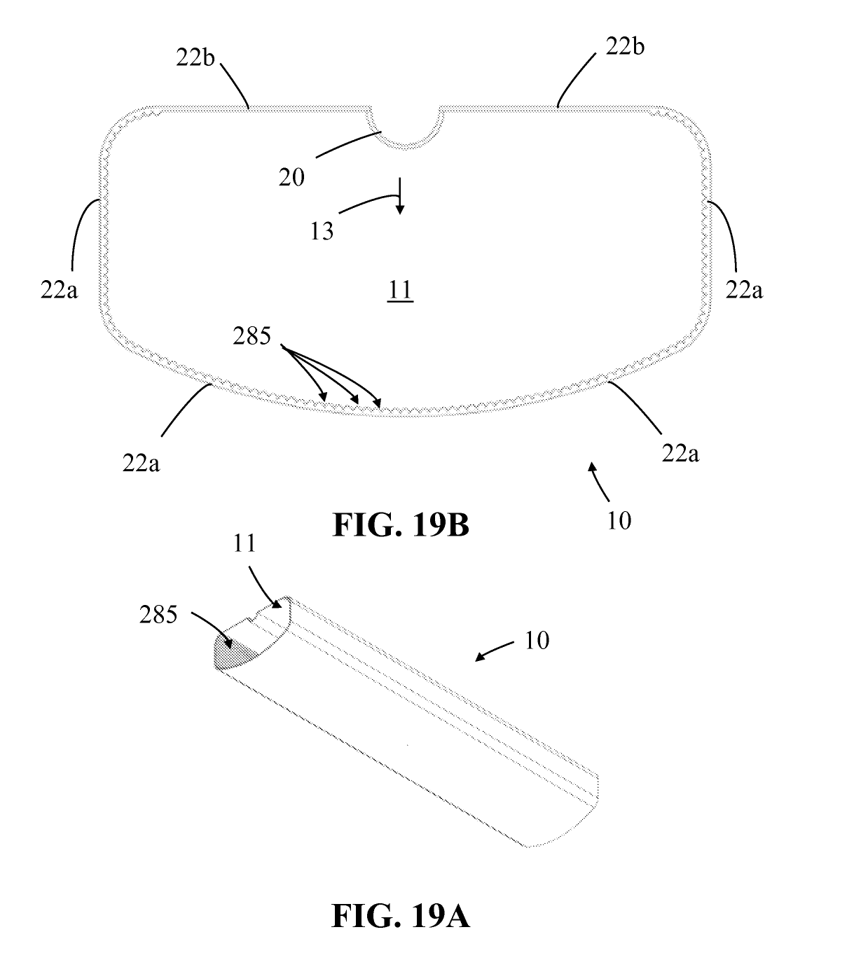

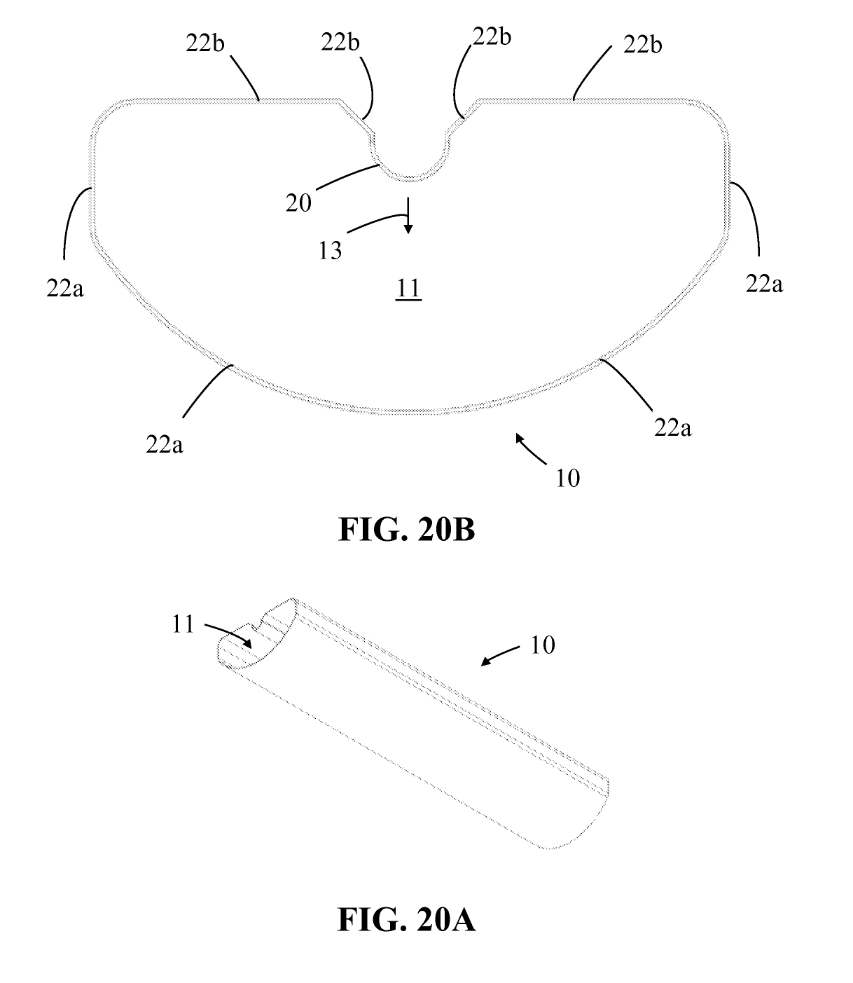

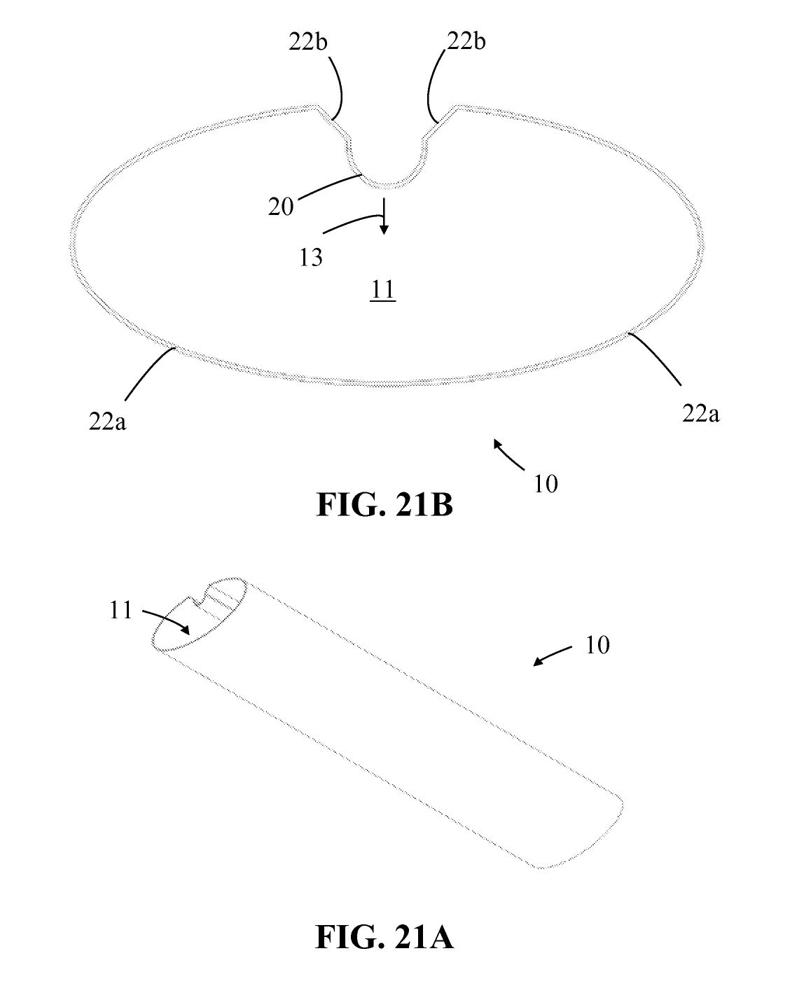

FIGS. 16A-B, 17A-B, 18A-B, 19A-B, 20A-B, and 21A-B illustrate examples of different shapes that can be used for the integrated component 10 in the surface mountable linear lamp 260. FIGS. 16A-B illustrate an embodiment where the diffuser portion 22a includes both a curved lower portion and relatively vertical side portions. In addition, channels 212 are formed in the component 10 to receive the heat sink and/or circuit board 160. The embodiment of FIGS. 17A-B is very similar to the embodiment of FIGS. 16A-B, except that channels 212 are not integrally formed in the component 10. This approach would therefore need an alternate way to mount the circuit board 160 to the component 10, e.g., with an adhesive or mounting screws.

FIGS. 18A-B illustrate an embodiment where the component 10 has smaller heights for the vertical side walls of the diffuser portion 22a. This creates a sectional profile for the component 10 that is relatively wider in the lateral dimension, but relatively narrower in the vertical dimension. In contrast, FIGS. 19A-B provides an embodiment where the component 10 has larger heights for the vertical side walls of the diffuser portion 22a. This creates a sectional profile for the component 10 that is relatively larger in the vertical dimension as compared to the vertical dimension.

FIGS. 20A-B illustrate an approach where the bottom portion of the diffuser portion 22a possesses a significantly greater curvature to its profile. This greater curvature is in combination with very small heights for the side vertical walls.

FIGS. 21A-B illustrate an approach which minimizes and/or completely eliminates the side vertical walls. In this approach, most of the wall length for the component is configured as a curved diffuser portion 22a, with only a very small portion 22b formed near the wavelength conversion portion 20.

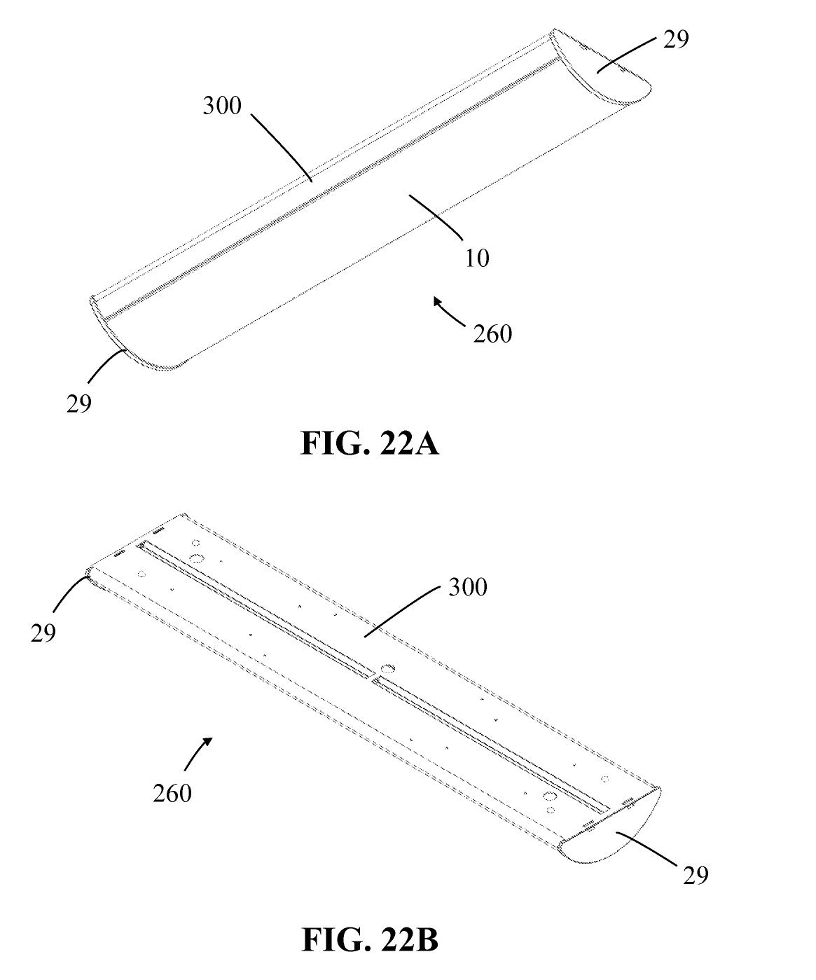

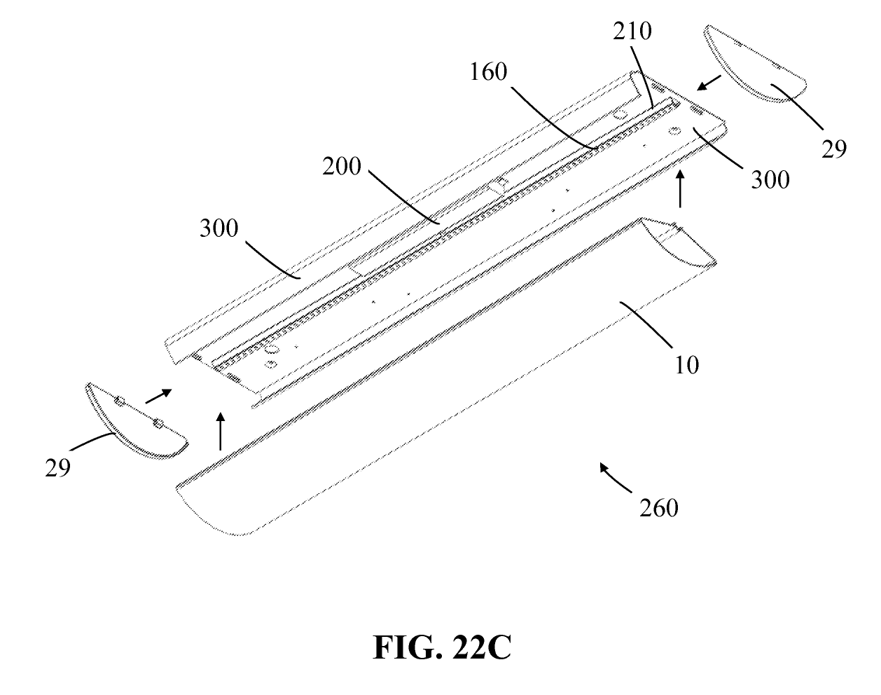

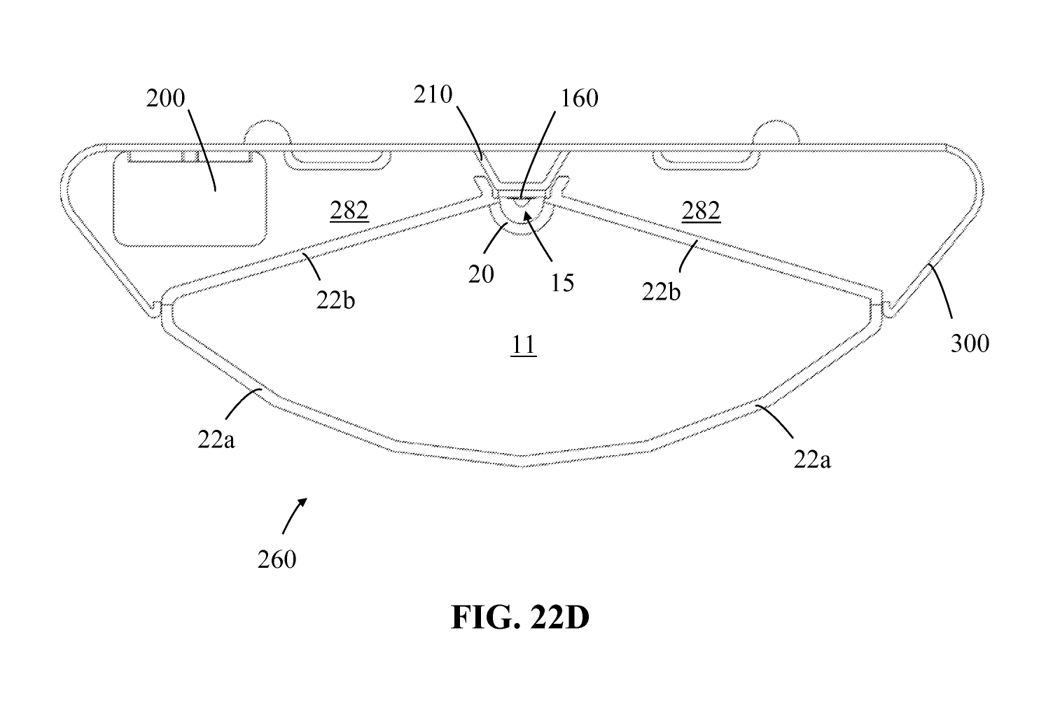

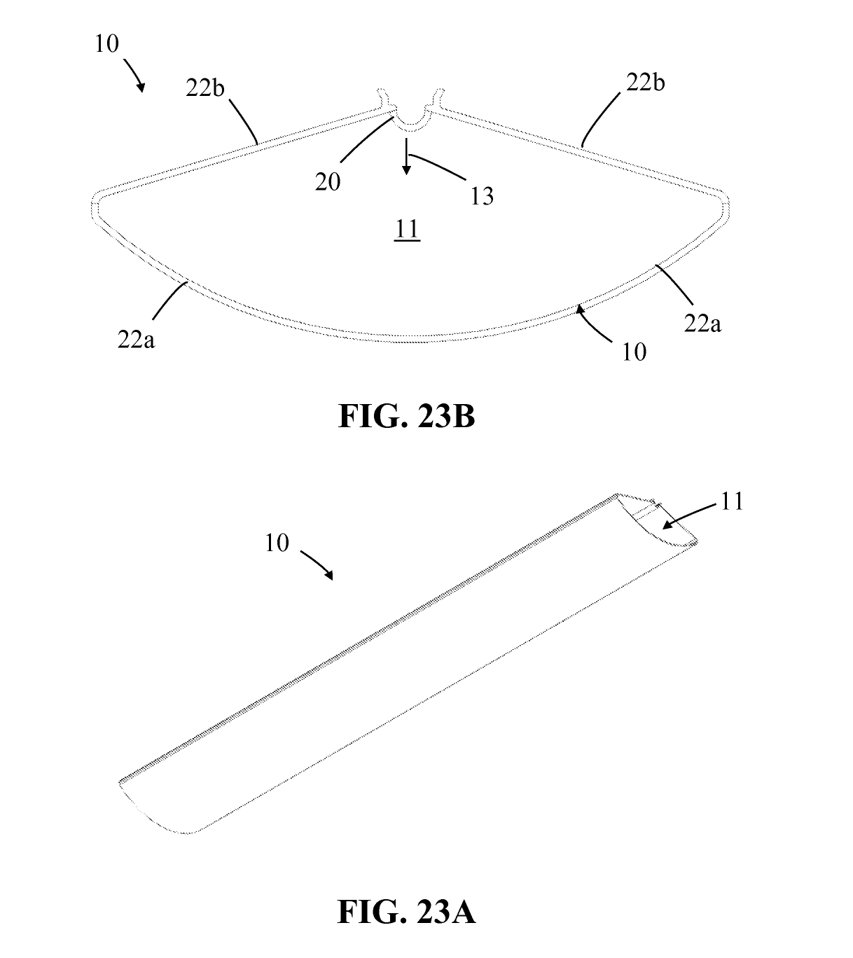

FIGS. 22A-D illustrate an alternative surface mountable wraparound linear lighting arrangement 260 according to embodiments of the invention. The surface mountable lighting arrangement 260 includes an integrated wavelength conversion component 10 as illustrated in FIGS. 23A-B. As before, the integrated wavelength conversion component 10 is formed as an integrated structure that includes different portions having different physical and/or optical properties. The integrated wavelength component 10 includes a wavelength conversion portion 20, a diffuser portion 22a, and light reflective portions 22b. The wavelength conversion component 10 comprises a profile formed as a continuous wall, and certain portions along the lengths of the wall correspond to the wavelength conversion portion 20, diffuser portion 22a, and reflective portions 22b. The lighting arrangement 260 further includes a body 300, end caps 29, substrate 160 and a heat sink 210. The substrate 160 contains an array of LEDs 21 and is affixed to the heat sink 210. As indicated in FIG. 23B the component 10 can include slots 212 to receive the substrate 160 and/or the heat sink 210.

The Body 300 can be formed of any suitable material, e.g., extruded aluminum or a thermoplastic. The component 10 is mounted within a body 300. It can be noted that body 300 is configured to cover all except for certain portions of the component 10 (e.g., bottom portion). This prevents the direct emission of light from lamp 260 except in an uncovered direction (e.g., in a generally downward direction). One reason for this type of configuration is to avoid having the lamp produce excessive amounts of visual glare to the users in lateral directions. Another advantage provided by body 300 is that it can function as a heat sink for the wraparound light. The body 300 can further comprise one or more slots or apertures or other fixing arrangements for mounting the lighting arrangement to ceiling or wall. Alternatively, and/or in addition, the end caps 29 can include fixing arrangements for mounting the lighting arrangement.

The component 10 can further include integrally formed shoulders at the junction between the diffusive and reflective portions 22a, 22b that run along the length of the component. Such shoulders can be configured to cooperate with the inner surface of the body 300 to thereby permit the component 10 to be mounted to the body 300 with a snap fit.

In the current embodiment the component 10 and body 300 are configured such that the light reflective portions 22b of the component in conjunction with the body 300 define an internal volume 282 along the length of each edge of the lighting arrangement for housing a power supply 200 or other driver circuitry. The lighting arrangement 260 is assembled by mounting the power supply 200 within the body 300 and then mounting the LED lighting arrangement within the body 300 and applying the caps 29 to each end.

Some embodiments pertain to wraparound linear lighting arrangements where the wavelength conversion and top portions are integrally formed, but the bottom portion comprises a separate component. These different portions may be manufactured using any suitable manufacturing approach. For example, all of these portions can be extruded (with some portions co-extruded), and/or where some of the portions are not extruded but are instead manufactured using a different manufacturing approach (e.g., vacuum molded).

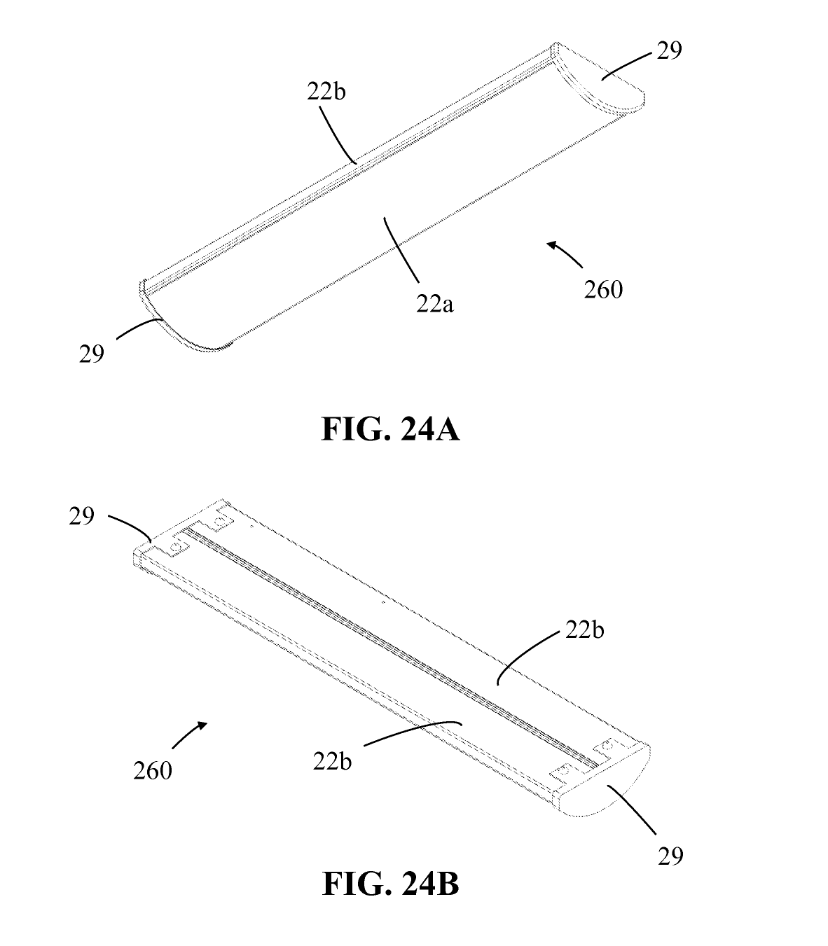

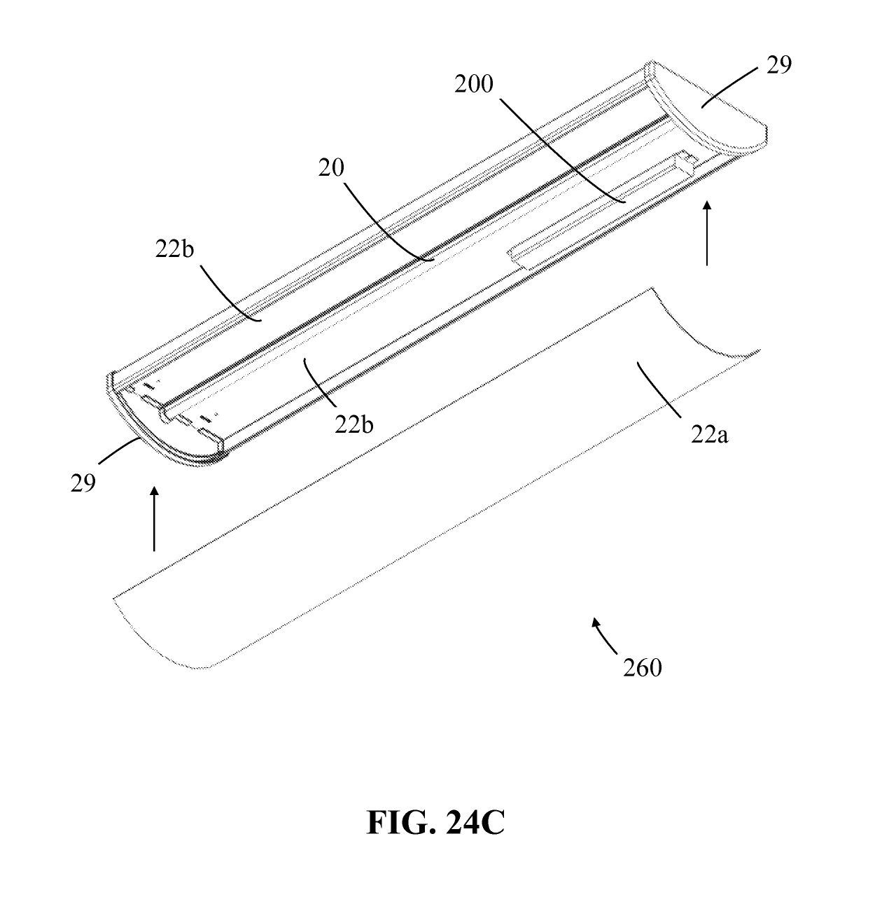

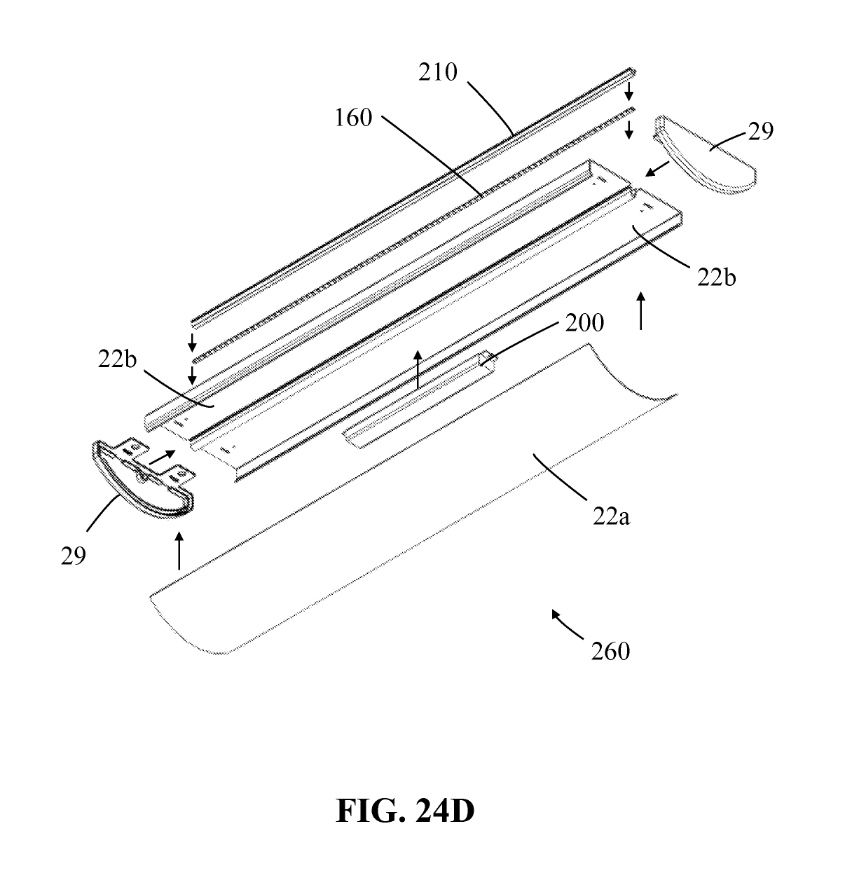

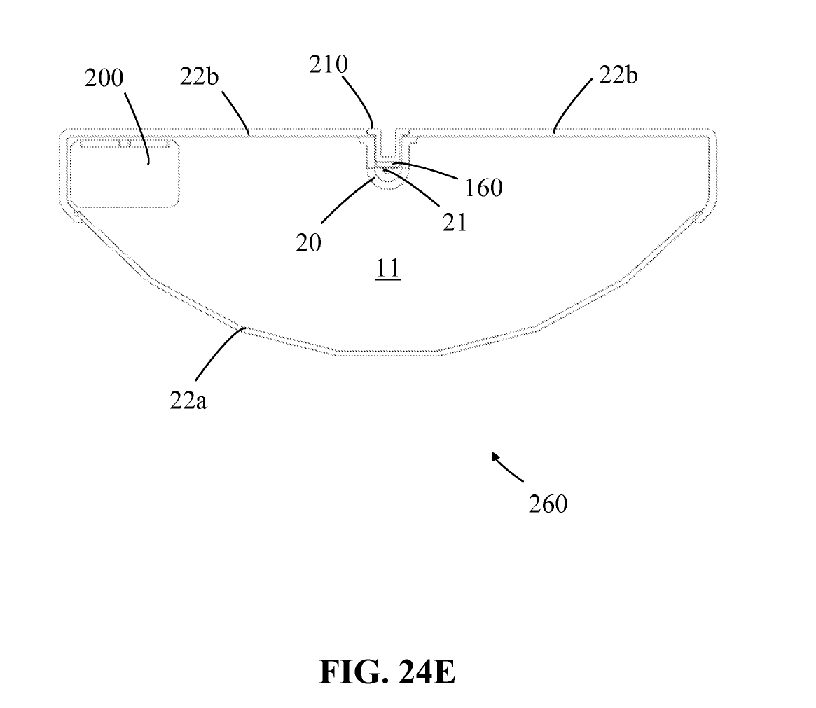

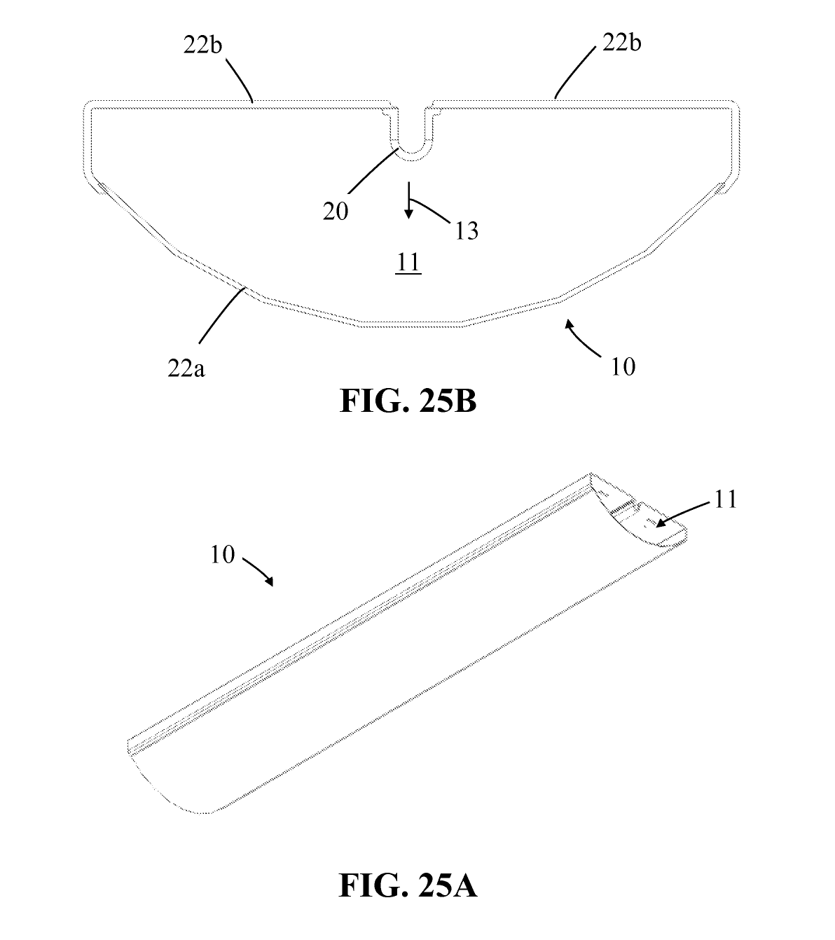

FIGS. 24A-E illustrate a further surface mountable wraparound linear lighting arrangement 260 according to embodiments of the invention and an integrated wavelength conversion component 10. FIGS. 25A-B illustrate an integrated wavelength conversion component 10 for use in the lighting arrangement of FIGS. 24A-E. As before, the integrated wavelength conversion component 10 comprises a wavelength conversion portion 20, a diffuser portion 22a, and light reflective portions 22b. In contrast to the earlier embodiments the wavelength conversion 20 and light reflective portions 22b are integrally formed and the diffuser portion 22a comprises a separate manufactured component. In this embodiment the light reflective portions 22b constitute the body of the lighting arrangement eliminating the need for a separate body as in the previous embodiment of FIGS. 22A-D. The diffusive portion 22a and/or light reflective portion 22b are preferably manufactured from acrylic. The lighting arrangement 260 further includes caps 29, substrate 160 and a heat sink 210. The substrate 160 contains an array of LEDs 21 and is affixed to the heat sink 210.

The light reflective portions 22b can further comprise one or more slots or apertures or other fixing arrangements for mounting the lighting arrangement to ceiling or wall. Alternatively, and/or in addition, the caps 29 can include fixing arrangements for mounting the lighting arrangement.

In the current embodiment the internal volume 11 of the component 10 can be used to house a power supply 200 or other driver circuitry. The lighting arrangement 260 is assembled by mounting the power supply 200 within the component 10 and then mounting the diffuser portion 22a to the component 10 and applying the caps 29 to each end of the arrangement. The diffusive portion 22a and light reflective portions 22b can include features enabling them to be secureably attached to each other by for example a snap fit. In the embodiment illustrated the light reflective portions 22b can be substantially rigid and the light diffusive portion 22a can be resiliently deformable enabling insertion of the light diffusive portion 22a by mechanical flexing.

An advantage of having the component 10 in two parts (i.e. portions 20, 22b and portion 22a) is that this enables the mounting and electrical connection of the power supply 200 within the lighting arrangement. Another advantage of this approach is that its provides a way for installation and/or maintenance personnel to access the interior of the lighting arrangement, while still allowing the final arrangement to be assembled to have a closed-wall profile. Furthermore, the arrangement of FIGS. 24A-E is significantly cheaper to produce since it only comprises so few components: a wavelength conversion component 10 (composed of two parts), caps 29, LEDs 21, 160 and optionally a heat sink 210. In this embodiment it will be appreciated that wavelength conversion component not only provides light generation and distribution it additionally provides an electrical enclosure for the LEDs and power supply. Such a lighting arrangement is believed to be inventive in its own right.

Another advantage of having the components separately manufactured is that this approach permits individually formed combinations of selectable properties for the top portions relative to the selectable properties of the bottom portions. For example, the integral top portion/wavelength conversion portions may be manufactured such that the top portion 22b for a first variant is clear while a second variant is reflective. Meanwhile, the bottom portion 22a is manufactured in a first variant to include diffuser materials, while a second variant does not include diffuser materials. This permits a first combination where the top portion is clear while the bottom portion comprises a diffuser, a second combination where the top portion is clear while the bottom portion is without diffuser, a third combination where the top portion is reflective while the bottom portion comprises a diffuser, and a fourth combination where the top portion is reflective while the bottom portion is without a diffuser.

### Task Lighting Arrangements

The invention can also be applied to implement task lights, which can be mounted in any location to provide task lighting. For example, task lights can be mounted in an under-cabinet location to provide lighting at a counter or desk location.

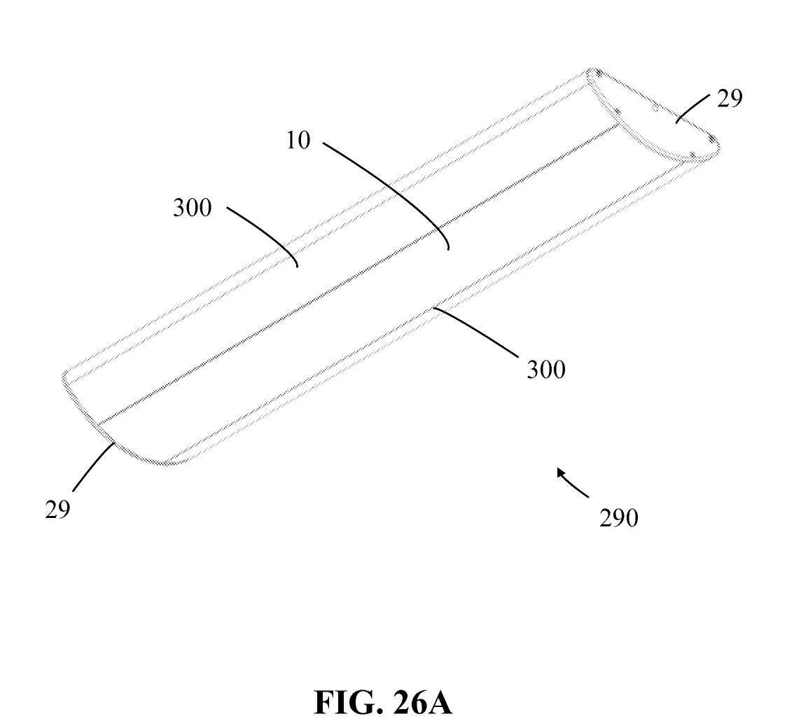

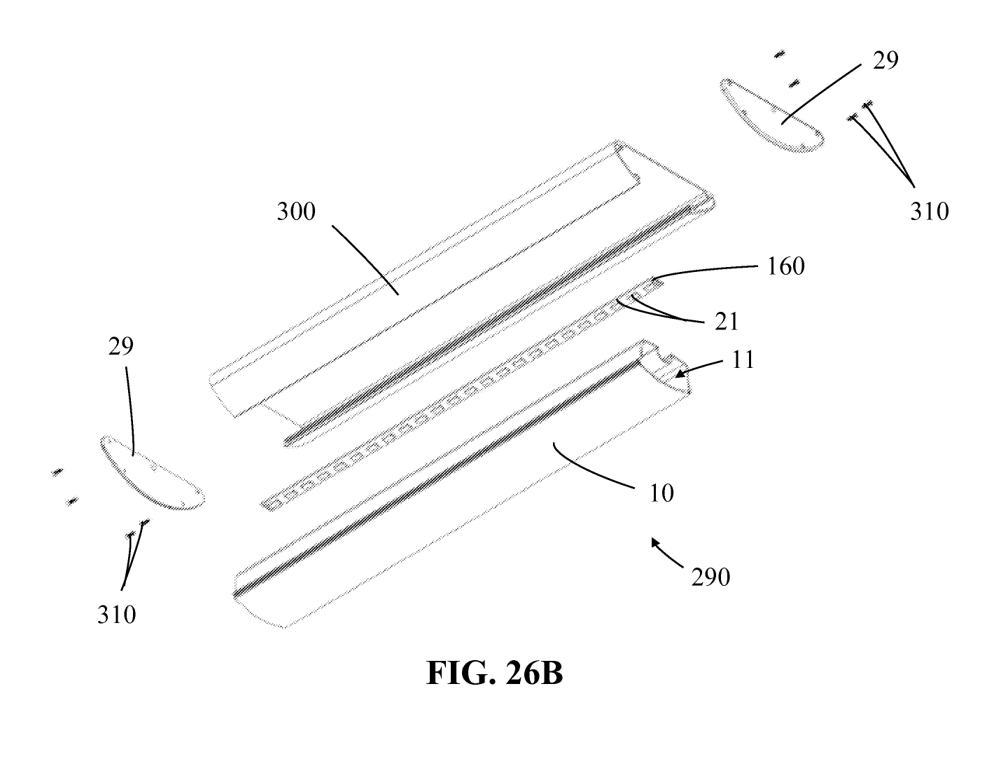

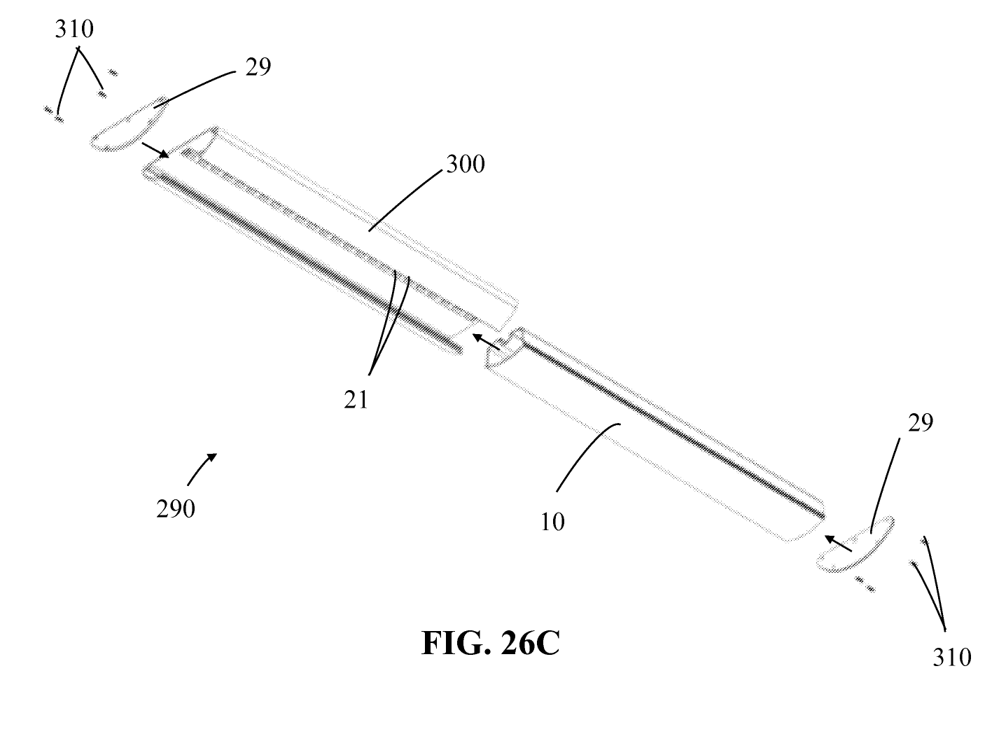

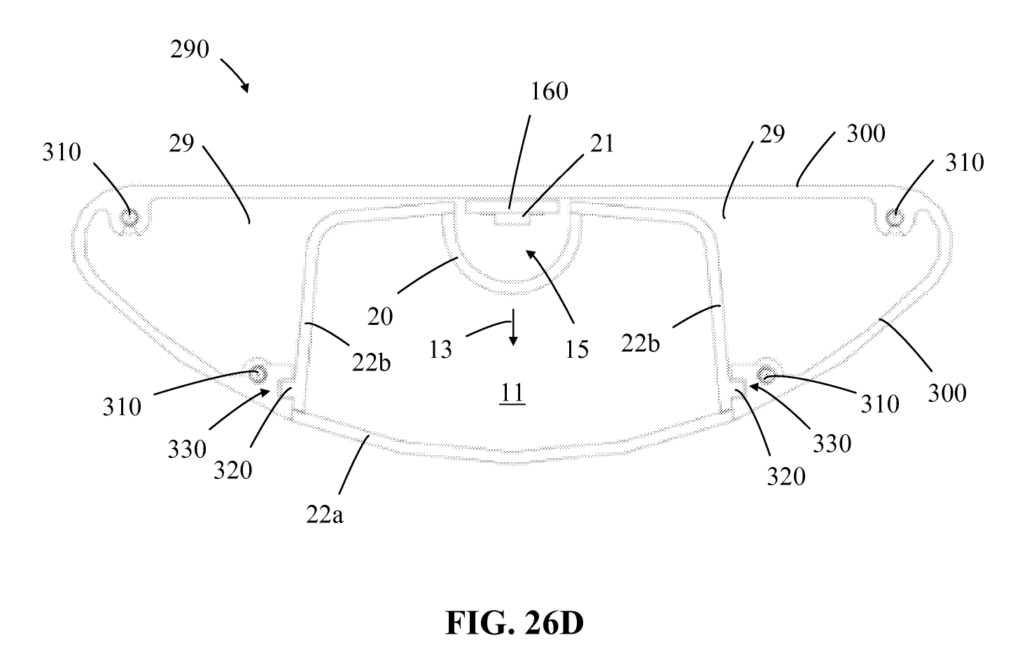

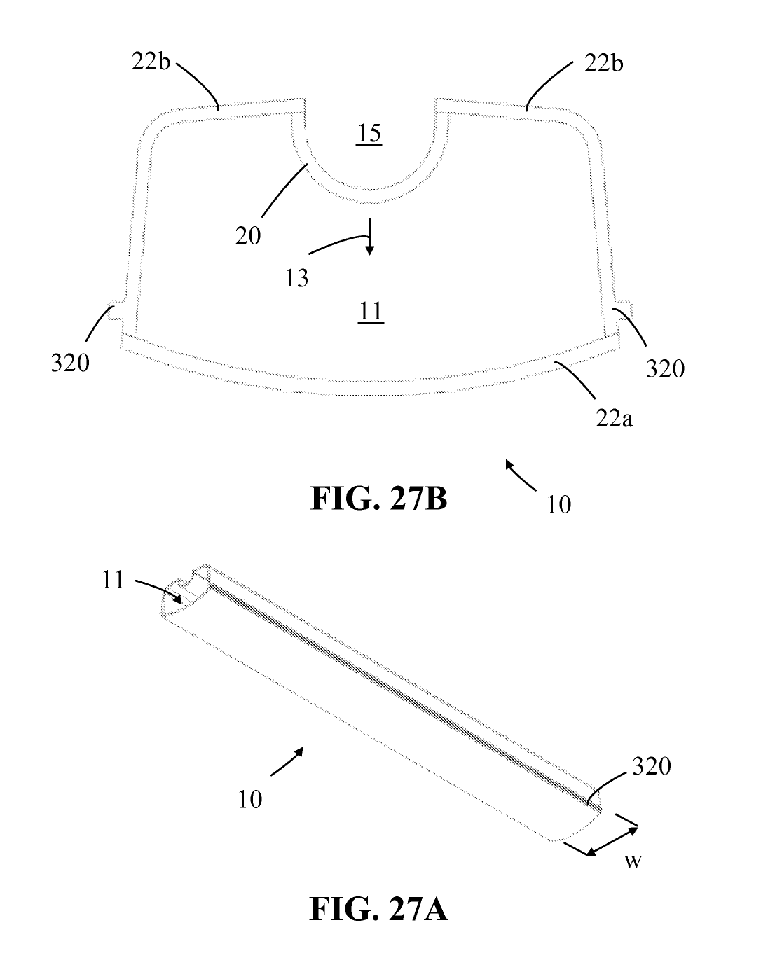

FIGS. 26A-D illustrate a task light 290 according to some embodiments of the invention. FIGS. 27A-B illustrate an integrated wavelength conversion component 10 for use in the lighting arrangement of FIGS. 26A-D. Similar to the other embodiments described herein, the task light 290 includes an integrated wavelength conversion component 10 that includes a wavelength conversion portion 20 having one or more photoluminescence materials which absorb a portion of the excitation light emitted by the LEDs 21 and re-emit light of a different color. In the current embodiment, the top portion 22b of the component is formed as a reflector portion comprising a light reflective material, e.g., a light reflective plastics material. Alternatively the reflector can comprise a metallic component or a component with a metallization surface. The integrated wavelength conversion component 10 also includes a diffuser portion 22a that is integrally formed into the component 10.

The component 10 is mounted within a body 300. It can be noted that body 300 is configured to cover all except for certain portions of the component 10 (e.g., bottom portion). This prevents the direct emission of light from lamp 290 except in an uncovered direction (e.g., downwards direction). One reason for this type of configuration for the task light 290 is to avoid having the lamp produce excessive amounts of visual glare to the users in lateral directions. Another advantage provided by body 300 is that it can function as a heat sink for the task light 290. Body 300 can be formed of any suitable material, e.g., extruded aluminum or thermoplastic.

The task light 290 includes wavelength conversion component end caps 29, and substrate 160. The substrate 160 contains an array of LEDs 21 and is affixed to the body 300. Mounting screws 310 are used to mount the end caps 29 to the body 300.

The component 10 can be formed with shoulders 320 integrally formed along the edge of portions 22b to cooperate with corresponding channels 330 in body 300. This permits component 10 to be mounted to the body 300.

It is envisioned that in a typical application of a task lamp the integrated wavelength conversion component 10 has a width w (i.e. a dimension in a direction orthogonal the direction of elongation of the component FIG. 27A) of about one point six inches (1.6″).

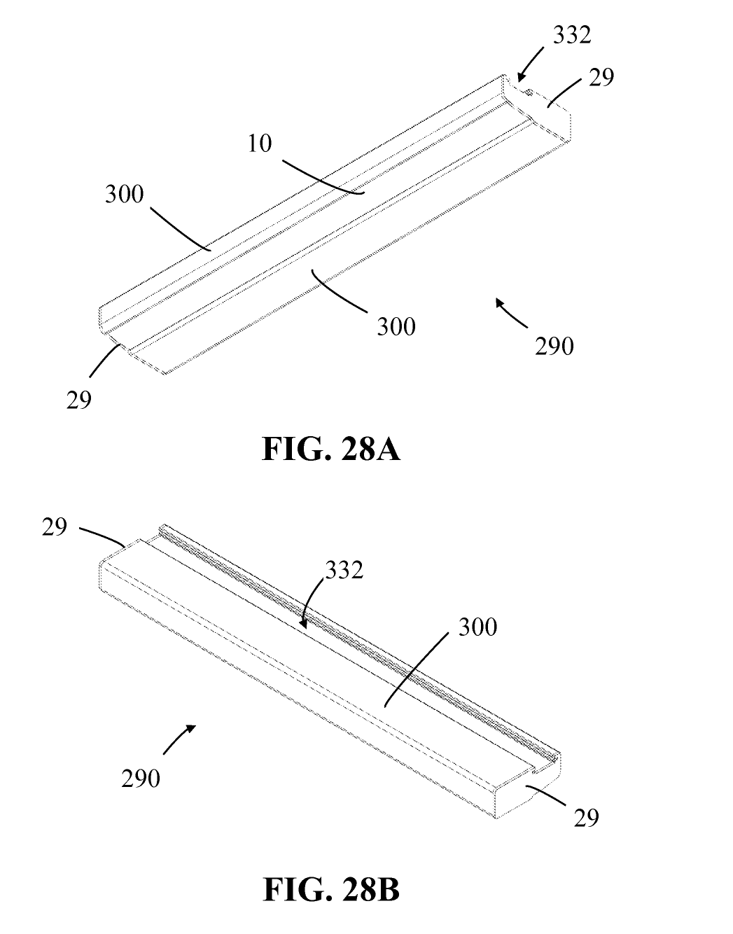

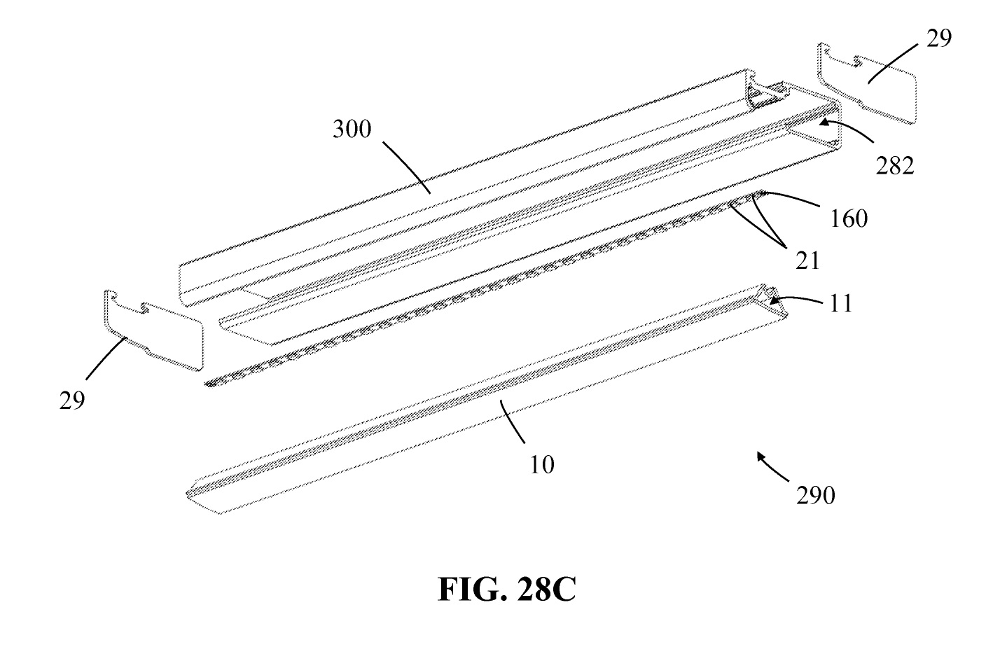

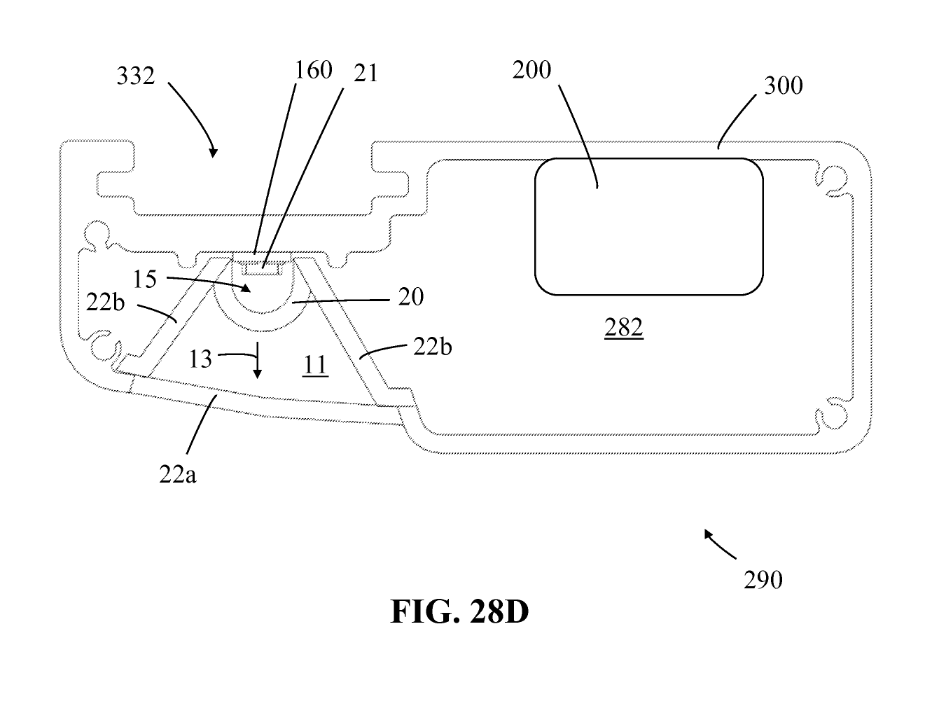

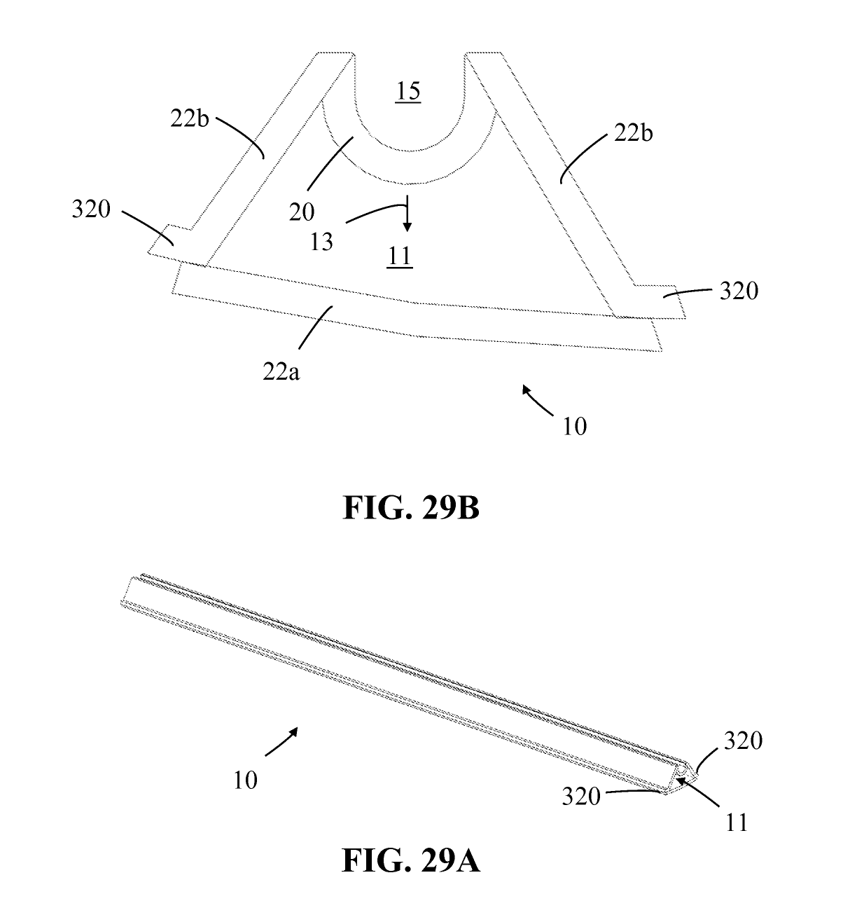

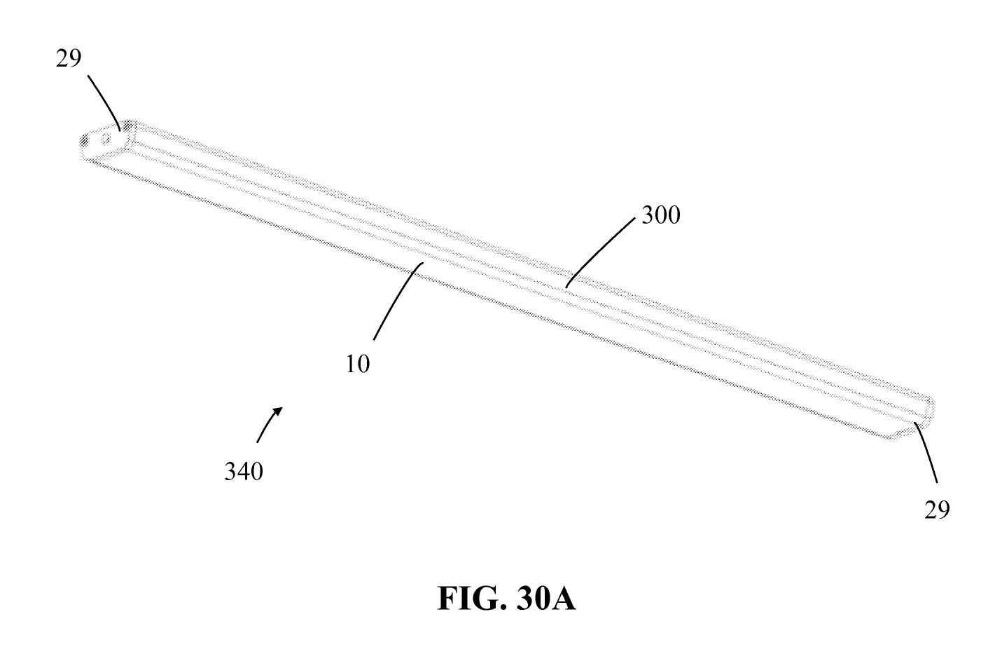

FIGS. 28A-D illustrate a task light 290 according to some embodiments of the invention. FIGS. 29A-B illustrate an integrated wavelength conversion component 10 for use in the lighting arrangement of FIGS. 28A-D. The task light 290 is very similar to the embodiment of FIGS. 26A-D except that the wavelength conversion component 10 is mounted to towards one lateral edge of the housing 300. As indicated in FIG. 28D the housing 300 can include an integrally formed channel 332 to facilitate mounting of the task light to a mounting bracket (not shown).

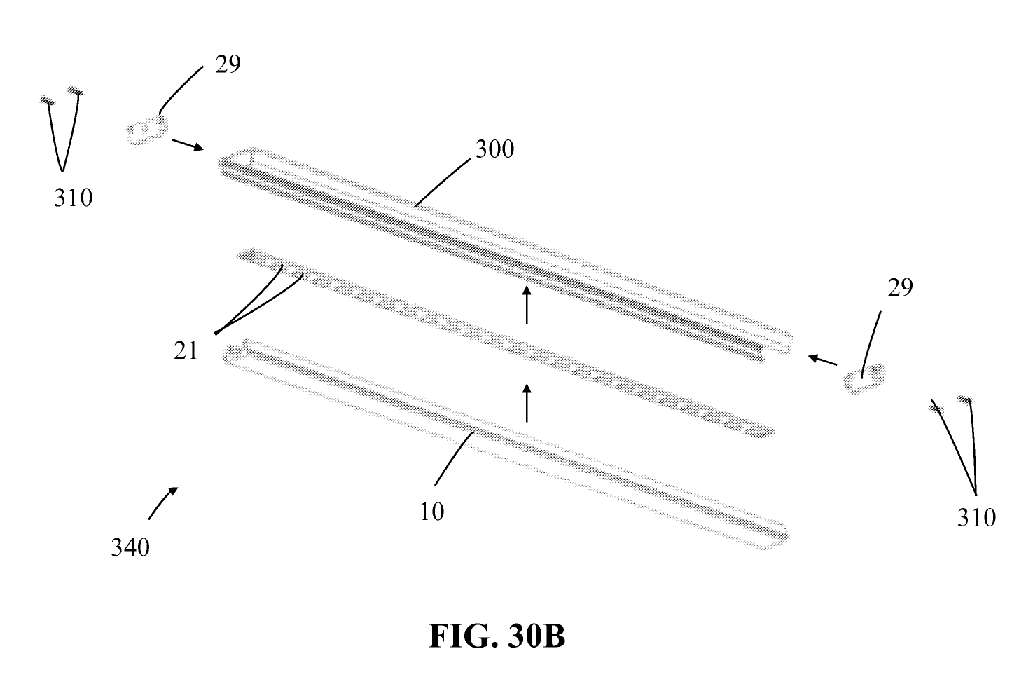

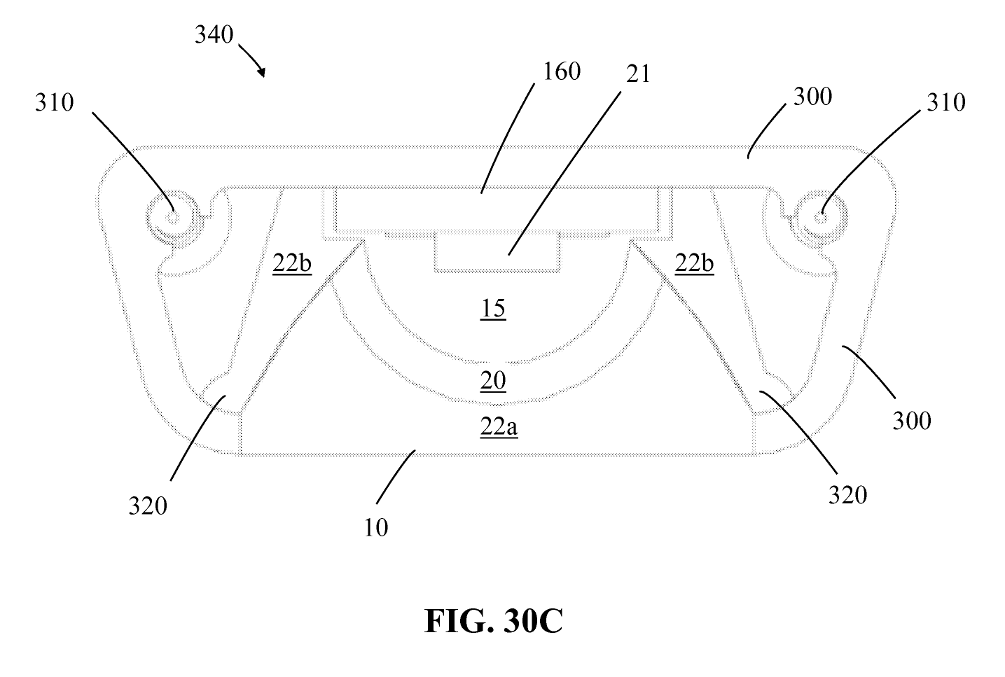

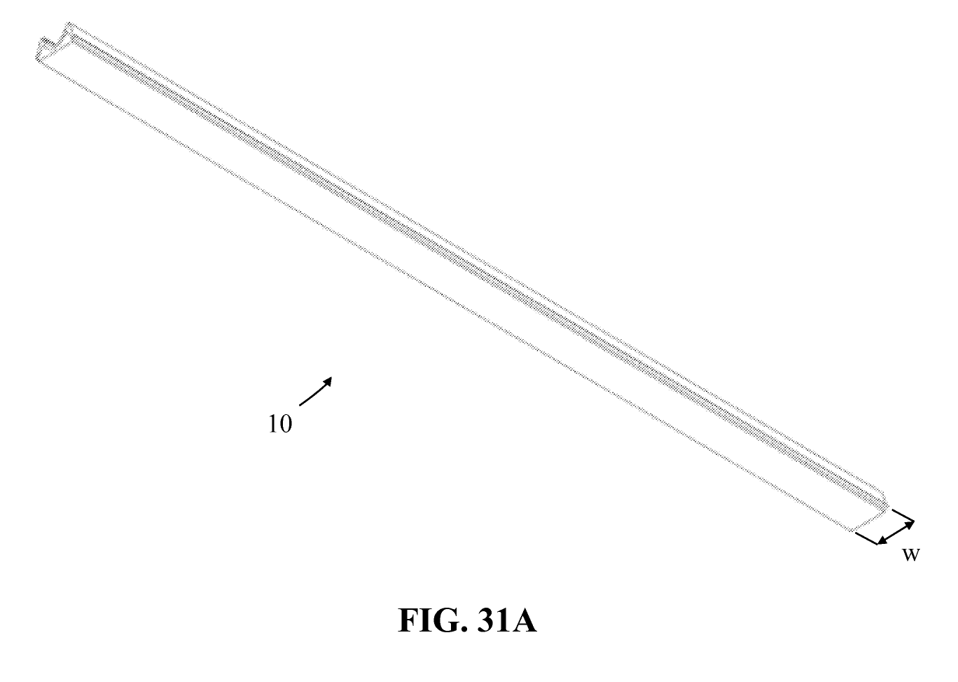

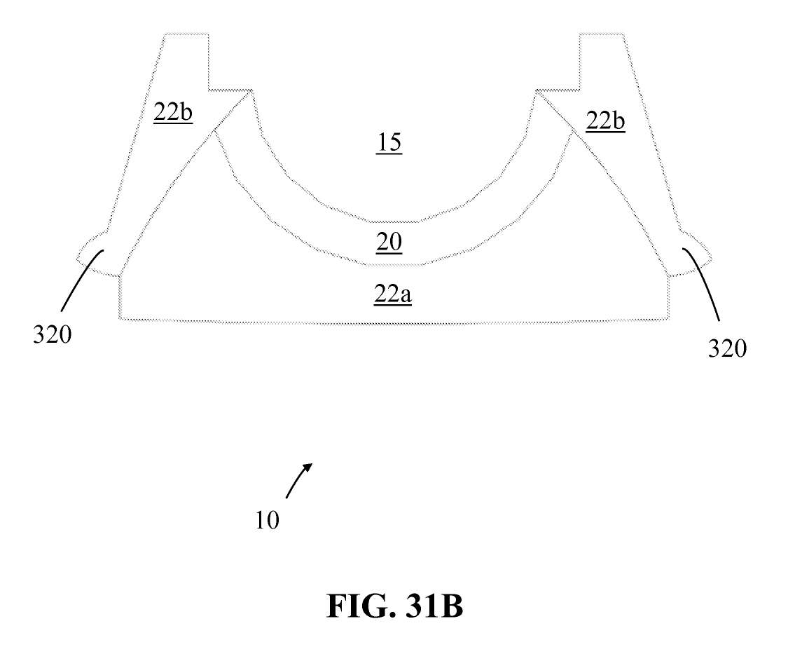

FIGS. 30A-C illustrate a mini task light 340 according to some embodiments of the invention. FIGS. 31A-B illustrate an integrated wavelength conversion component 10 for use in the mini task light 340 of FIGS. 30A-C. Similar to the other embodiments described herein, the mini task light 340 includes an integrated wavelength conversion component 10 that includes a wavelength conversion portion 20 having one or more photoluminescence materials which absorb a portion of the excitation light emitted by the LEDs 21 and re-emit light of a different color. In contrast to the earlier embodiments the wavelength conversion component 10 is solid rather than hollow. The top portion 22b of the component is formed as a reflector portion comprising a light reflective material, e.g., a light reflective plastics material. Alternatively, the reflector 22b can comprise a metallic component or a component with a metallization surface. The integrated wavelength conversion component 10 also includes a diffuser portion 22a that is integrally formed into the component 10 and fully fills the volume 11. In other embodiments the portion 22a can be light transmissive and a light diffusive layer and/or coating be provided on the light surface of the component. Such a light diffusive layer can conveniently be integrally formed as a further co-extrusion during manufacture of the component.

The component 10 is mounted within a body 300. It can be noted that body 300 is configured to cover all except for certain portions of the component 10 (e.g., bottom portion). This prevents the direct emission of light from lamp 290 except in an uncovered direction (e.g., downwards direction 13). One reason for this type of configuration for the mini task light 340 is to avoid having the lamp produce excessive amounts of visual glare to the users in lateral directions. Another advantage provided by body 300 is that it can function as a heat sink for the mini task light 340. Body 300 can be formed of any suitable material, e.g., extruded aluminum or thermoplastic.

The mini task light 340 includes wavelength conversion component end caps 29 and substrate 160. The substrate 160 contains an array of LEDs 21 and is affixed to the body 300. Mounting screws 310 are used to mount the end caps 29 to the body 300.

The component 10 can be formed with shoulders 320 integrally formed along the edge of portions 22b to cooperate with the inner surface of the body 300. This permits component 10 to be mounted to the body 300.

It is envisioned that in a typical application of a mini task lamp 340 the integrated wavelength conversion component 10 has a width w (i.e. a dimension in a direction orthogonal the direction of elongation of the component FIG. 31A) of about zero point six inches (0.6″).

Any of the disclosed embodiments may include additional structures along portions of the integrated component 10 to provide desired emission characteristics. For example, as shown in the surface mountable lighting arrangement of FIG. 19B, a series of ridges and/or features 285 can be formed into portion 22a of the component 10 to effect a desired emission characteristic of the lighting arrangement. In one embodiment, for example, a Fresnel lens may be formed into the component 10. The use of optical structures (such as Fresnel and other lens shapes) in the clear plastic can be used, for example, to create optical beam control from the lamp. The exact lighting effect to be achieved is based at least in part upon the size, shape, and/or distance of the feature from the LED array, as well as the shape of the optical lens. If the component 10 is manufactured using an extrusion process, then the exact spacing of those features can be controlled by the extrusion equipment to essentially form a fixed lens assembly. In other embodiments a flexible sheet diffuser and/or Fresnel lens can be inserted into the internal volume 11 of the wavelength conversion component.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

What is claimed is:

1. A lamp component, comprising:
a hollow extruded component,
the hollow extruded component comprising a photoluminescence portion and a light shaping portion; wherein the combination of the photoluminescence portion and the light shaping portion form a continuous-walled structure having a profile that defines a hollow interior volume; and
the photoluminescence portion extending into an interior volume of the hollow extruded component and comprising at least one photoluminescence material.

2. The lamp component of claim 1, wherein the photoluminescence portion and the light shaping portion are co-extruded.

3. The lamp component of claim 1, wherein the photoluminescence portion and at least a part of the light shaping portion are separately manufactured.

4. The lamp component of claim 3, wherein the at least a part of the light shaping portion is extruded.

5. The lamp component of claim 1, wherein the light shaping portion comprises a top portion, and the top portion is substantially light transmissive, light diffusive or light reflective.

6. The lamp component of claim 5, wherein the photoluminescence portion, the top portion or the combination of the photoluminescence and top portions forms a channel to receive a substrate having an array of light emitting diodes.

7. The lamp component of claim 1, wherein the light shaping portion comprises a bottom portion, and the bottom portion is substantially light transmissive, light diffusive or light reflective.

8. The lamp component of claim 1, wherein the light shaping portion comprises a diffuser portion having a generally rounded profile or a generally V-shape profile.

9. The lamp component of claim 1, wherein the photoluminescence portion comprises a conic profile, a generally rounded profile or a generally V-shape profile.

10. The lamp component of claim 1, wherein the hollow extruded component comprises an elongated shape.

11. A linear lighting arrangement, comprising:
a hollow co-extruded component, the hollow co-extruded component comprising a photoluminescence portion, a diffuser portion, and a top portion, wherein the photoluminescence portion, the diffuser portion, and the top portion define an interior volume, wherein the photoluminescence portion comprises at least one photoluminescence material and extends into the interior volume; and
a troffer body for receiving the co-extruded component.

12. The linear lighting arrangement of claim 11, wherein the troffer body comprises a plastic material.

13. The linear lighting arrangement of claim 11, wherein the troffer body comprises a light reflective material.

14. The linear lighting arrangement of claim 11, wherein the diffuser portion comprises diffusing material for generating direct lambertian light emissions; and
the top portion comprises a light transmissive material for directing emitted light upwards to be reflected by the troffer body for indirect light emissions.

15. The linear lighting arrangement of claim 11, wherein at least 25% of total light output from the lighting arrangement is indirectly reflected from the troffer body and at least 25% of the total light is directly emitted through the diffuser portion.

16. The linear lighting arrangement of claim 11, wherein the optical component in combination with a heat sink functions as an approved electrical enclosure.

17. A method of fabricating an optical component, comprising co-extruding an elongated hollow body having a photoluminescence portion, a diffuser portion, and a top portion, wherein the photoluminescence portion, the diffuser portion, and the top portion are all integrally formed in the body, the photoluminescence portion extending into an interior volume of the optical component and comprising at least one photoluminescence material and the diffuser portion comprising diffusing material.

18. The method of claim 17, in which co-extrusion is performed using at least one of: Polycarbonate, Poly(methyl methacrylate), Polyethylene Terephthalate, and thermoform plastics.

19. The method of claim 17, wherein vacuum extrusion is performed to extrude the optical component.
